(19) United States
(12) Patent Application Publication
(10) Pub. No.: US 2002/0169539 A1
(43) Pub. Date: Nov. 14, 2002

(54) Method and system for wireless tracking

(76) Inventors: Raymond J. Menard, Hastings, MN (US); McNeil Bryan, Amery, WI (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/112,669

(22) Filed: Mar. 28, 2002

Related U.S. Application Data
(60) Provisional application No. 60/279,401, filed on Mar. 28, 2001.
(60) Provisional application No. 60/279,513, filed on Mar. 28, 2001.

(51) Int. Cl. G01C 21/30

(52) U.S. Cl. 701/200; 701/213

(57) ABSTRACT

Management of location information communicated using wireless devices and communication networks. Authorization to access location information may be granted implicitly, explicitly or in light of predetermined circumstances. Location information and navigation tools can be used to find, or avoid, a particular location. Location information may be generated by a mobile device-based section, by a communication network-based section or by a combination of device-based and network-based sections. Location information may be integrated with emergency response facilities to provide police, fire or medical assistance.

### RELATED APPLICATION

This application claims priority to U.S. Provisional Patent Application serial No. 60/279,401, entitled VARIABLE DISTANCE RF TAG DISCLOSURE, and filed on Mar. 28, 2001, the specification of which is hereby incorporated by reference.

This application claims priority to U.S. Provisional Patent Application serial No. 60/279,513, entitled RANGE AND BEARING INDICATOR FOR WIRELESS DEVICE, and filed on Mar. 28, 2001, the specification of which is hereby incorporated by reference.

This application is related to U.S. patent application Ser. No, 09/793,373, entitled EMERGENCY RESPONSE INFORMATION DISTRIBUTION, and filed on Feb. 26, 2001, the specification of which is hereby incorporated by reference.

### TECHNICAL FIELD

This document relates generally to personal security and wireless networks and particularly, but not by way of limitation, to two-way wireless locating systems.

### BACKGROUND

The increasing amount of global movement of goods and people has emphasized the shortcomings of current technology used for tracking. Typically, such systems include a wireless transmitter and a compatible receiver. If the transmitted signal is no longer discernable, then the receiver assumes that a range has been exceeded and an alarm is sounded. Generally, the transmitter is not in audible range of the alarm and thus, has no way of knowing the whereabouts of the receiver, or the direction in which the transmitter has departed.

Furthermore, after the transmitter is beyond the range of the receiver, in order to once again find the transmitter, the receiver is manually swept through an increasingly larger search grid. Searching in this manner is generally time intensive and costly.

In addition, parents interested in monitoring the whereabouts of their children are generally unwilling to allow private location information to be distributed without restrictions.

Such tracking systems are impractical for use with monitoring the whereabouts of children or movable objects.

Therefore, there is a need for an improved tracking system and method.

### SUMMARY

The present subject matter is directed to systems and methods for managing location information based on a geographical location of a mobile device. The mobile device is adapted to communicate using wireless communication technology. Examples of wireless communication technology include, but are not limited to, BLUETOOTH® technology, HomeRF® technology, cellular telephone technology, two-way pager technology, radio frequency (RF) technology, IEEE 802 technology and other wireless communication technology.

The mobile device maybe located in, on or around an object, person, animal, or other physical item. The mobile device may include hardware and programming to function as a cellular telephone, a two-way pager, a personal communication system (PCS), a personal digital assistant (PDA), a portable computer (laptop, palm-top) or other portable device. The present subject matter provides methods and systems by which access to the location information may be granted to selected recipients and denied to other recipients. In addition, the accuracy of the location information may be tailored to suit particular objectives.

The location information may be generated by a hardware module of the mobile device, by programming executing on hardware accessible to the communication network or by a combination of hardware within the mobile device and programming of the network.

In one embodiment, a secondary device receives, or requests, access to the geographical location information of the mobile device. In one embodiment, the relationship between the secondary device and the mobile device can be viewed as a master-slave relationship with the mobile device assuming the role of either the master or the slave. In one embodiment, the relationship between the secondary device and the mobile device can be viewed as a peer-to-peer relationship with both the mobile device and the secondary device having substantially equal rights. Thus, one embodiment provides that a plurality of mobile devices can be configured in a manner whereby a first subset of the plurality of mobile devices are able to access location information for a second subset of mobile devices and are denied access to a location information to a third subset of mobile devices.

In one embodiment, the mobile device includes a compass element. The compass element provides visible or audible directional information to a user. In this manner, the orientation of the mobile device can be adjusted and used as a direction finder.

In one embodiment, the present subject matter provides a translational element for converting a message in a first communication protocol into a second communication protocol. For example, assuming the mobile device includes a cellular telephone and a BLUETOOTH® transceiver and the secondary device to be used for monitoring the location of the mobile device includes a laptop computer not equipped with a BLUETOOTH® transceiver. Assume also that authorization has been granted to allow the secondary device to access the location information of the mobile device. In the event that location information from the mobile device is transmitted using the BLUETOOTH® transceiver, then an interface device, including hardware or software, provides a translation between the BLUETOOTH® communication protocol and a browser based program executing on the laptop computer. In one embodiment, the interface device converts data in a first structure into data in a second structure. In one embodiment, the interface device converts data communicated in a first communication protocol into data in a second communication protocol. The interface device may include a routine executing on the BLUETOOTH® transceiver at either the transmitter side or the receiver side of the communication link. In one embodiment, the interface device includes a routine executing at a network operating center or monitor center, in which case, data of one type (protocol or structure) is received by the monitor center and returned as data of a second type (having a different protocol or structure).

In one embodiment, location information is provided in real time to an emergency response service provider. Consider, for example, a situation wherein a mobile device is attached to, or carried on the interior, of a stolen automobile. The location of the mobile device is communicated to a public safety answering point (PSAP) facility.

In one embodiment, the location information is conveyed using a communication network. The network may be a local area network (LAN) or a wide area network (WAN) such as the Internet.

In one embodiment, security mechanisms of the BLUETOOTH® communication protocol are utilized to restrict access to the location information.

In one embodiment, the present system allows tracking of vehicles, assets, persons or animals. In one embodiment, the mobile device includes software and hardware. In one embodiment, the mobile device includes an electronic compass.

In one embodiment the mobile device includes software adapted to calculate and display relative distances and bearings to a target location using graphical or textual representations.

The second device may be stationary or mobile. The location information may be accessible using the portable device or accessible using the second device. In one embodiment, the relationship between the first device and second device can be viewed as a peer-to-peer relationship. In one embodiment, the relationship between the first device and the second device can be viewed as a slave-master relationship.

Other aspects of the invention will be apparent on reading the following detailed description of the invention and viewing the drawings that form a part thereof.

### BRIEF DESCRIPTION OF THE DRAWINGS

In the drawings, like numerals describe substantially similar components throughout the several views. Like numerals having different letter suffixes represent different instances of substantially similar components.

FIG. 1 is a schematic view of networked communications according to one embodiment of the present subject matter.

FIG. 2 is a block diagram of a mobile device according to one embodiment.

FIG. 3 illustrates serial communication between a mobile device and a monitor center.

FIGS. 4A, 4B and 4C illustrate location determining sections in various embodiments.

FIG. 5 illustrates a flow chart according to one embodiment.

FIG. 6 illustrates a flow chart according to one embodiment.

FIG. 7 illustrates a flow chart according to one embodiment.

FIG. 8 illustrates a flow chart according to one embodiment.

FIG. 9 illustrates a flow chart according to one embodiment.

FIG. 10 illustrates a screen shot of a computer display according to one embodiment of the present subject matter.

FIG. 11 illustrates a diagram of a second device.

FIG. 12 illustrates a diagram of a tag.

FIG. 13 illustrates an overview of the system.

FIG. 14 illustrates an embodiment of a personal tag system.

FIG. 15 illustrates an embodiment of a courier tracking system.

FIG. 16 illustrates an embodiment of a person-to-person tracking system.

FIG. 17 illustrates an embodiment of a person-to-person tracking system used by a response agent to find a person in need.

FIG. 18 illustrates an embodiment for requesting assistance from a monitor center.

FIG. 19 illustrates an embodiment of the present system used to discover a landmark or service.

FIG. 20 includes a block diagram of an example embodiment of a system according to the present system.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents.

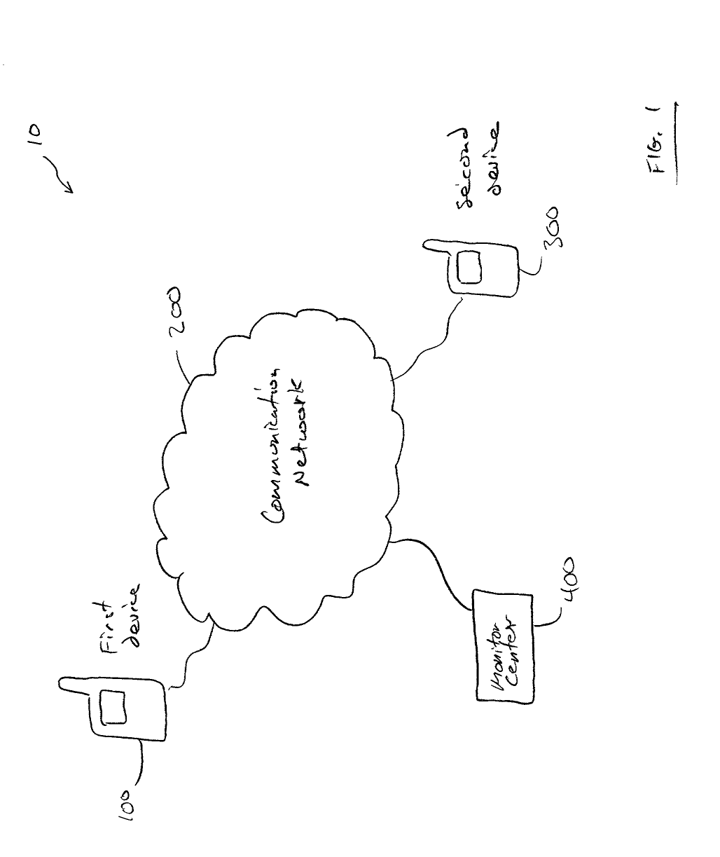

FIG. 1 illustrates system 10 including networked communications between first device 100, monitor center 400 and second device 300. In the following description, first device 100 is also referred to as mobile device 100. Communication network 200 may include a digital local area network (LAN) or a wide area network (WAN) such as the Internet. Other communication networks are also contemplated. For example, but not by way of limitation, network 200 may include a trunked radio network, a public switched telephone network (PSTN), a cellular telephone network, a two-way pager communication network.

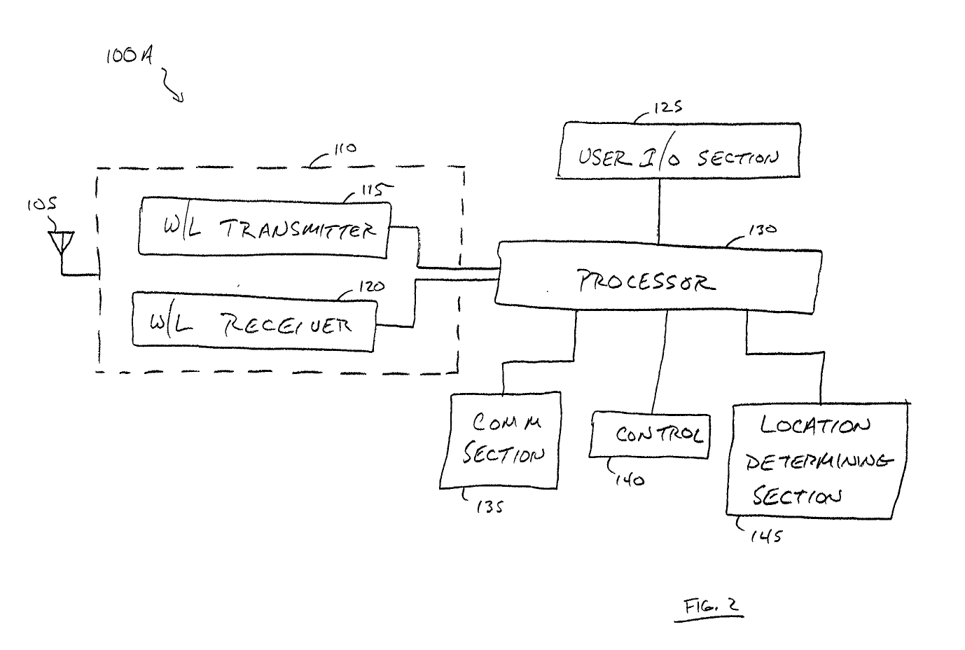

FIG. 2 illustrates a block diagram of one embodiment of mobile device 100A. In the figure, wireless transceiver 110, having wireless transmitter 115 and wireless receiver 120, are coupled to antenna 105. Wireless transceiver 110, in one embodiment, includes a short range radio frequency (RF) transceiver. In one embodiment, transceiver 110 includes a BLUETOOTH®-compatible transceiver, a HomeRF®-compatible transceiver, an IEEE 802 transceiver or other wireless communication transceiver.

Transceiver 110 is coupled to processor 130. In one embodiment, processor 130 includes a microprocessor or other computer. Processor 130 is coupled to I/O section 125 which may include audio transducers (such as a speaker, microphone), a user accessible keypad or buttons, or a visual display (such as a liquid crystal display (LCD) or light emitting diode (LED) display). Also coupled to processor 130 are communication section 135, control 140 and location determining section 145.

Communication section 135 may include, for example, a cellular telephone transceiver, a two-way pager transceiver, a personal communication transceiver, or other communication transceiver. In one embodiment, communication section 135 includes a long range radio frequency (RF) communication transceiver.

Control 140, in one embodiment, includes a switch to control the exchange of data between location determining section (LDS) 145 and transceiver 110 or between LDS 145 and comm section 135. In one embodiment, the switch includes hardware or software. In various embodiments, control 140 includes programming executing on processor 130 or programming and hardware to manage the transmission of location information from device 100A to remote receivers. Control 140 may represent a hardware device or a software routine.

Location determining section 145, in one embodiment, includes a global positioning system (GPS) receiver or a long range navigation (LORAN) receiver. The output of LDS 145 is supplied as an electronic location signal to processor 130, and in one embodiment, and depending on the status of control 140, is provided to transceiver 110 or comm section 135. The electronic location signal may include digital data or an analog signal representing a geographical location.

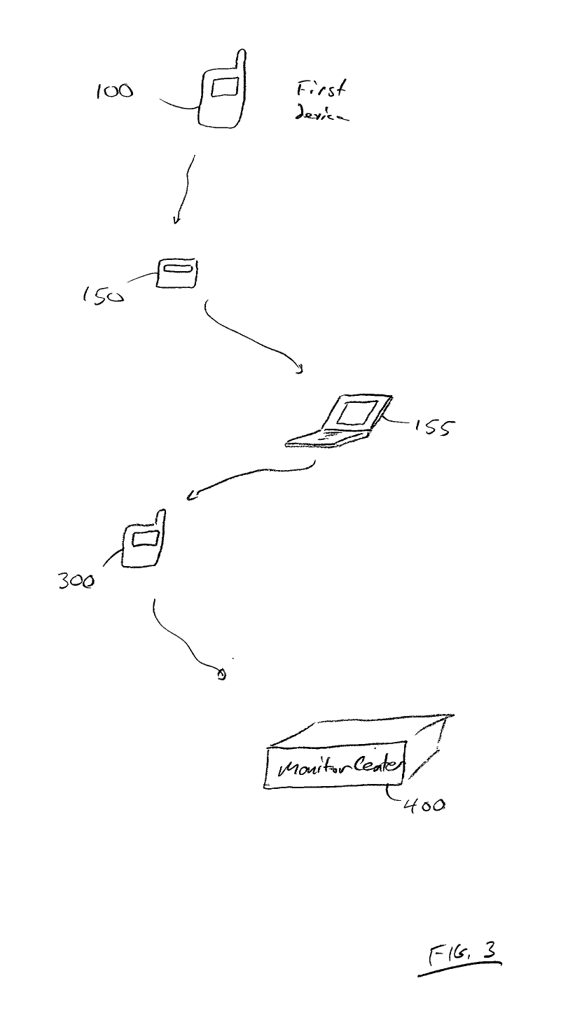

FIG. 3 illustrates serial communications between first device 100 and monitor center 400. Consider an example whereby first device 100 is carried by a child. In this case, the location information of the child is to be safeguarded and access to the information is limited to authorized users only. Here, device 100 includes a short range transceiver such as BLUETOOTH® and using frequency hopping spread spectrum technology, the transceiver communicates the location information of device 100 to BLUETOOTH®-compatible pager device 150. In the event that pager device 150 is not an authorized recipient of the location information, then security protocols implemented by BLUETOOTH® precludes access to the location information by a user of pager device 150. The location information is relayed, or forwarded, to laptop 155 using either the two-way pager transceiver or the BLUETOOTH® transceiver of pager device 150. If laptop 155 is authorized to receive and access the location information, then the location information is displayed on the screen of laptop 155. Displaying location information on laptop 155 may include rendering a map image or textual description. In the event laptop 155 is not authorized to access the location information, then a transceiver executing in laptop 155 relays or forwards the information to second device 300. In one embodiment, laptop 155 is coupled to a network connection, either by a wired or wireless connection, and the location information is routed across the network to monitoring center 400. Second device 300, in one embodiment, includes a transceiver that relays the information to monitor center 400 using a wireless connection. In this example, second device 300 is authorized to access the location information. A display screen of the second device 300 depicts a map, graphical image, or textual message representing the location information. In one embodiment, the location information is forwarded in a data stream, thus providing nearly real time representation of the location of first device 100.

In one embodiment, programming executing on device 300, or device 100, determines the range between device 300 and device 100. Range information may be displayed on a display screen of device 100 or device 300. In one embodiment, programming executing on device 300 determines the relative bearing to device 100. Bearing information may be displayed on a display screen of device 300. In one embodiment, programming executing on device 100 determines the relative bearing to device 300. Bearing information may be displayed on a display screen of device 100.

In one embodiment, device 300, or device 100, receives screen data from a monitor center, a central station, or a network center. The screen data includes coding to allow device 300, or device 100, to render a graphical image including such fields showing relative orientation, bearing, distance and other data. In one embodiment, the screen data is generated by a third party device and provided to device 300 or device 100 by wireless transmission.

In one embodiment, an alarm signal is triggered if range or bearing information exceeds or falls below a predetermined threshold. Monitoring center 400 is adapted to automatically notify an emergency authority if such conditions exist.

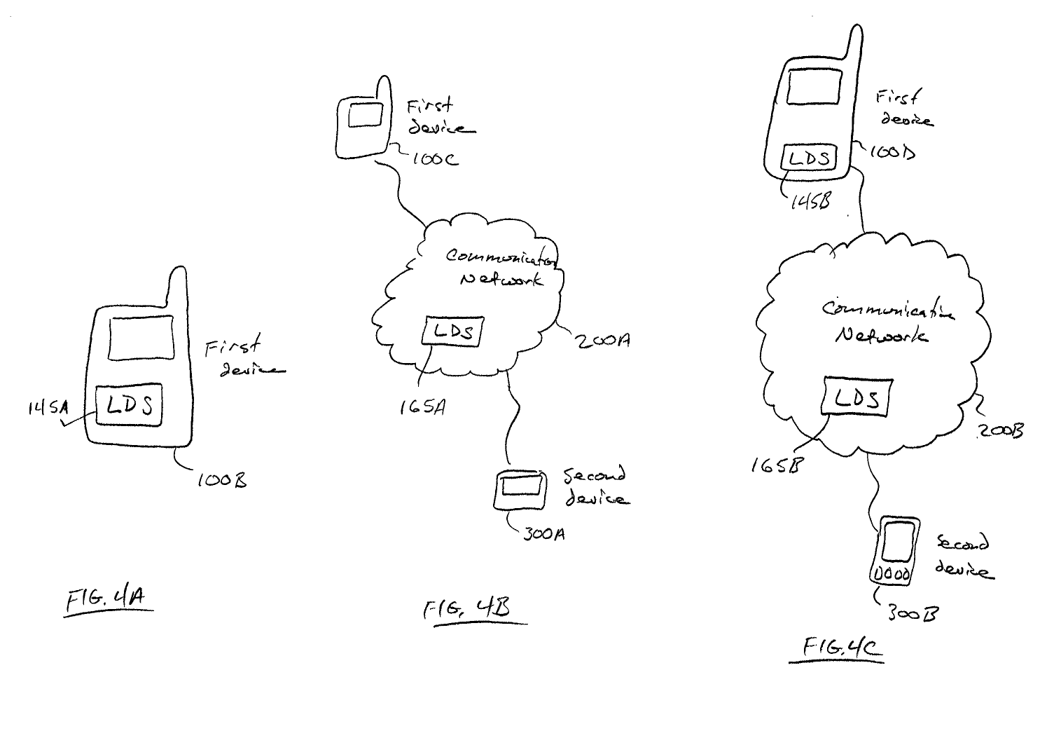

FIGS. 4A, 4B and 4C illustrate that the location determining section may be mobile device-based, network-based, or a combination of device-based and network-based. FIG. 4A illustrates one embodiment of location determining section 145, herein depicted as LDS 145A. In the figure, LDS 145A is integrated with device 100B. For example, LDS 145A may include a GPS receiver positioned internal to device 100B. FIG. 4B illustrates communication network 200A having integral LDS 165A. Location information, in one embodiment, is based on a geographical location of first device 100C and is determined based on timing information for wireless signals between network 200A and device 100C. Second device 300 is also connected to communication network 200A. In one embodiment, a server coupled to network 200A includes programming to determine location information and selected clients accessing the server are able to receive the location information. Selected clients are those authorized to receive the location information. FIG. 4C illustrates LDS 145B and LDS 165B within first device 100D and network 200B, respectively. In such an embodiment, the combination of information generated by LDS 145B and LDS 165B provides the location information.

In one embodiment, device 100 includes an electronic circuit or an electronic circuit and programming for determining location. In one embodiment, LDS 145 uses a terrestrial location system. There are several varieties of terrestrial solutions, including time differential, signal strength, angle of arrival and varieties of triangulation. In one embodiment, LDS 145 uses a combination of terrestrial and satellite navigation systems.

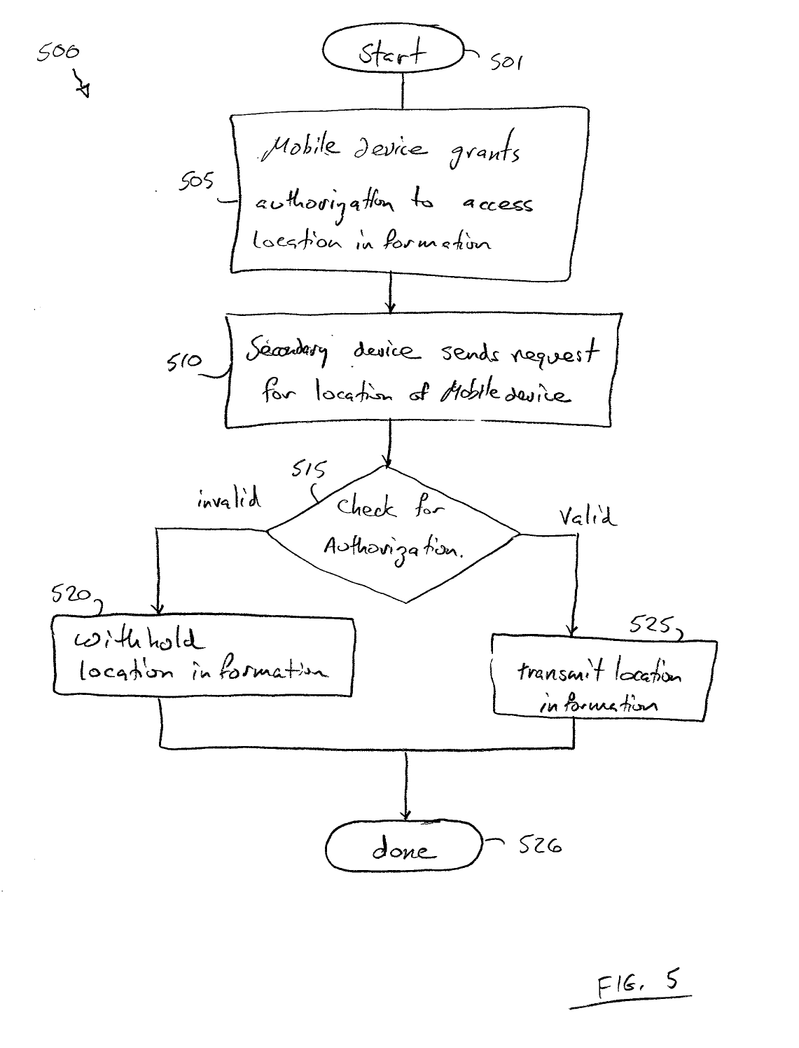

FIG. 5 illustrates a flowchart of method 500 according to one embodiment of the present system. Method 500 depicts a portion of a method implemented by a processor executing a program according to one embodiment. After start 501 and at 505, a mobile device grants authorization to access location information for the mobile device. The mobile device may include a suitably equipped cellular telephone transceiver, a two-way pager transceiver, a PCS transceiver or a PDA device with a transceiver. Other transceivers are also contemplated, and in one embodiment, the mobile device includes a transceiver dedicated for use as described herein. In one embodiment, the granting of authorization to access location information may be performed by a network element, such as a server, or a supervisory device or agent for the mobile device. For example, mobile device 100 may be a slave to the monitoring, or second, device 300.

At 510, the secondary device 300 submits a request to receive location information for mobile device 100. The request may be a coded message. The request may be received by device 100 or by communication network 200. In one embodiment, the request includes an authorization code. The absence of an authorization code is handled as though the authorization code were invalid.

At 515, the method performs a check of the authorization. Multiple authorization codes may be valid. In the event that the authorization is valid, at 525, the location information is transmitted to the second device 300. The location information may be transmitted by a network element, such as a server, or by device 100. In the event that the authorization is invalid, at 520, the location information is withheld and not communicated to that requester. This portion of the method ends at 526.

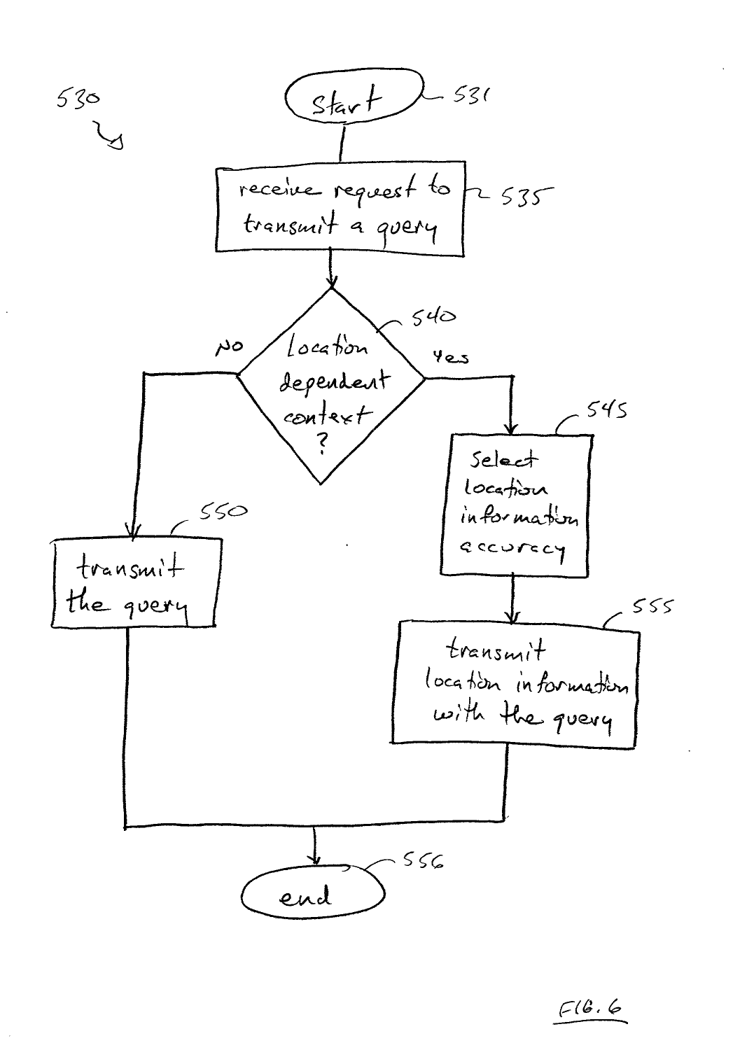

FIG. 6 illustrates a flowchart of method 530 according to one embodiment. After starting at 531, the method includes receiving a request to transmit a query. For example, the query may include a coded message such as “where is the nearest automatic teller machine (ATM)?” The coded message may be transmitted in response to user activation of a particular programmed key or a spoken command. At 540, the method determines if the request includes a location-dependent context. A location-dependent context may relate to the question of “where?” A suitable reply to a request having a location-dependent context includes evaluation of the location of the requester. The ATM example illustrates a location-dependent context. Location-dependent context requests include implicit authorizations to access location information.

The method proceeds to 545 if the request includes a location-dependent context and to 550 if not. At 545, the method includes selecting a suitable location information accuracy. For example, to locate the nearest ATM machine, a low accuracy response is adequate. In one embodiment, accuracy need not be greater than 1000′ resolution and an expected reply might include a list of the five nearest ATM machines. Thus, the accuracy of the location information is degraded to provide a measure of privacy protection for the requester. On the other hand, if the request calls for the nearest fire department, geographical accuracy will be more important than privacy protection for the requester, and in that case, accuracy may be degraded to a 50′ resolution.

At 555, the location information, along with the query, is transmitted. As noted the location information may be degraded.

If the query is not location-dependent, then at 550, the query is transmitted without inclusion of the location information. This portion of the method ends at 556.

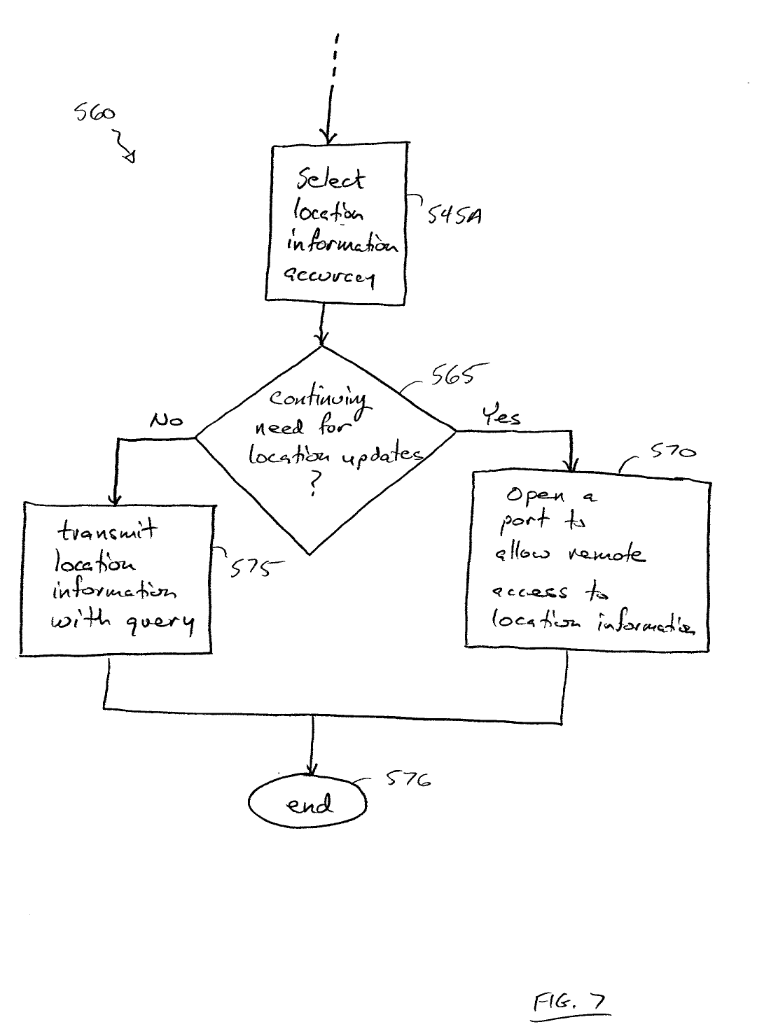

FIG. 7 includes a portion of a method commencing with 545A wherein the location information accuracy is selected. At 565, the method determines if the nature of the request justifies continuing updates to the location information. For example, if a suitable response to the query includes periodic updates, as may be appropriate for travel information, then the method proceeds to 570. At 570, a port is opened to allow remote access to location information for a predetermined time period. If updated location information is not needed, then at 575, the location information is transmitted with the query and no further updates are provided. The method ends at 576.

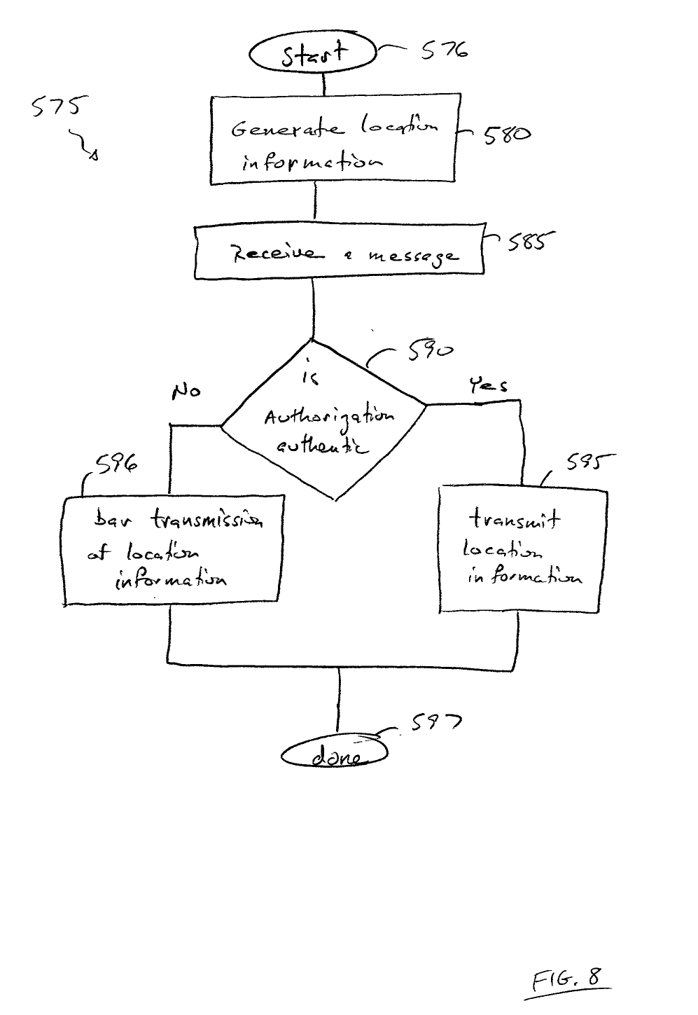

FIG. 8 illustrates a flowchart according to one embodiment. Beginning at 576, at 580, the location information is generated. The location information may be generated by the mobile device or by the communication network or a combination of the device and the network. At 585, a message is received. The message may include, for example, a request to send location information. For instance, a parent may send a message requesting the whereabouts of a child carrying a mobile device. The message may be sent from a computer, a cellular telephone, a BLUETOOTH®-equipped device, a PDA, a PCS or other such device. The message, in one embodiment, includes an authorization. The authorization may include a password or coded message. The authorization, at 590 is checked for authenticity. If the authorization is authentic, then at 595, the location information is transmitted. If the authorization is not authentic, then at 596, the transmission of location information is barred. The method ends at 597.

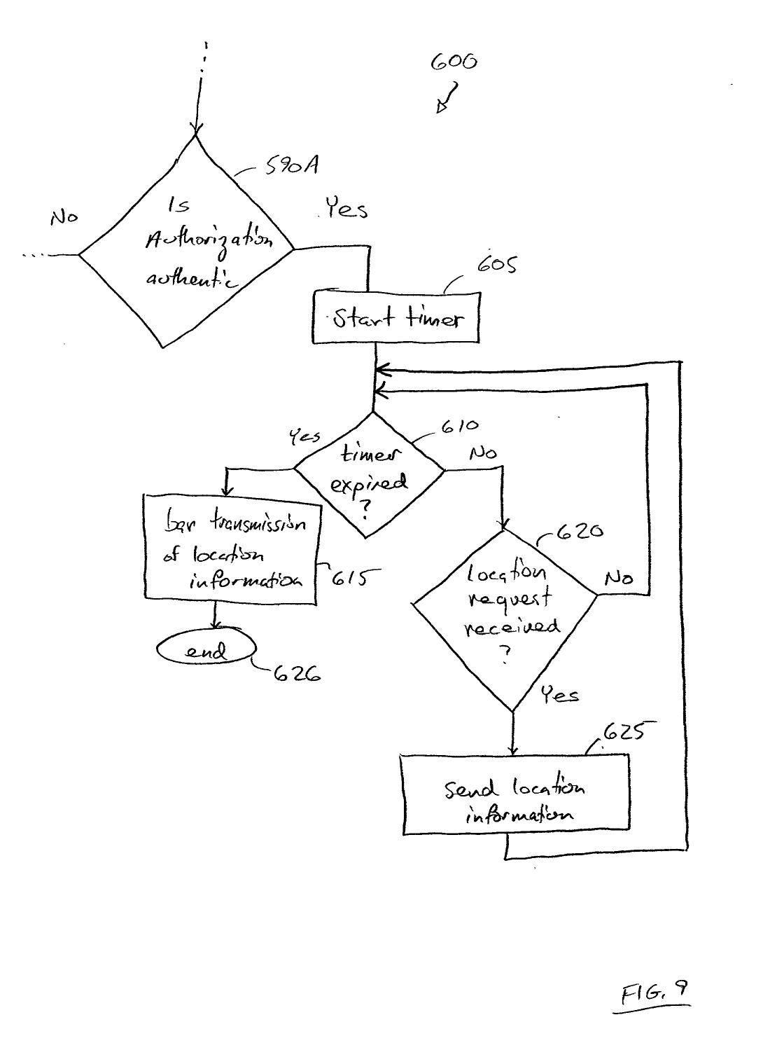

FIG. 9 illustrates a portion of one embodiment of a method including time-limited access to location information. At 590A, the method determines if the authorization is authentic. If so, at 605, a timer is started. The timer may be implemented in software or hardware within the network or device 100. The duration of the timer may be user-selectable using hardware or software. The timer may include a user-operable control at either end of the communication link. At 610, the method determines if the timer has expired. If not expired, then, at 620, the method determines if a request for location information has been received. If not, then the method returns to 610. If a request for location information has been received, then after sending location information at 625, the method returns to 610. In the event that the timer has expired, at 615, the transmission of location information is barred. Other methods of limiting the time of accessibility to location information are also contemplated.

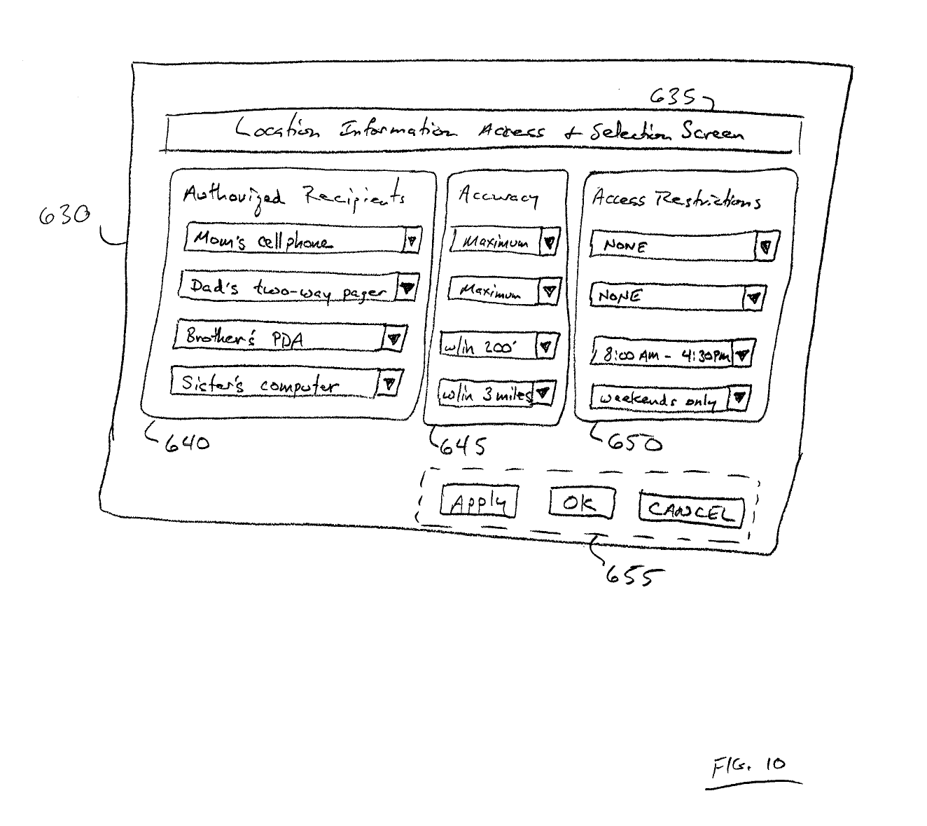

FIG. 10 illustrates a screen shot appearing on a computer display according to one embodiment of the present system. For example, a teenager may access screen 630 using a computer. In one embodiment, the program is server based and accessible by a network connection, such as a LAN or WAN (for example, the Internet). In one embodiment, the screen is generated by software executing on a personal computer. In field 635, the user is notified that this screen is known as the Location Information Access and Selection Screen. Fields within portion 640 allow user selection of authorized recipients of the location information for the teenager's mobile device. Pull-down menus allow user selection of predetermined recipients and their associated devices. Fields within portion 645 allow the teenager to specify the location information accuracy for each of the authorized recipients. As noted, some are to receive maximum accuracy (limited by the technological hardware and program available) and others are to receive degraded accuracy. Fields within portion 650 allow the teenager to specify restrictions on access to the location information. As noted in the figure, some recipients have no restrictions and others have time-dependent restrictions. Portion 655 allows changes to be applied or cancelled. Other screens are also contemplated which allow customization of the distribution of the location information.

In various embodiments, security methods are implemented to restrict access to location information. For example, in one embodiment, the location of mobile device 100 is only released with authorization of the user of mobile device 100. Authorization may be granted implicitly in a request or directly. In the absence of authorization, then location information is not released.

In one embodiment, an authority can override restrictions on access that may have been implemented by a user. For example, in an emergency, a court order or subpoena may force the release of location information without user authorization.

In one embodiment, the location information is generated by network-based technology. In such an embodiment, the authorization to access location information is resolved by one or more servers coupled to the network. In one embodiment, the communication network has a trust relationship with a particular user and the user authorizes the network to release the location information.

In one embodiment, the location information is generated by device-based technology. In such an environment, the authorization to access location information is resolved by hardware and programming within the device. Examples of device-based location information technology includes GPS and LORAN technology. Programming executing on a processor within the mobile device manages the access to the location information.

In one embodiment, the location information entails both network-based and device-based technology. In such an environment, the authorization to access location information is resolved by the combination of the network (servers) and the mobile device. For example, the mobile device may include a GPS receiver and programming executing on a processor coupled to the network manages the access to the location information. In one embodiment, the network is engaged in a trust relationship with a user and the user authorizes the network to release the location information.

In one embodiment, location information is transferred from a first network to the a second network, such as the Internet. Security protocols used with Internet communication or e-commerce may be used for transmitting location information. Examples include secure sockets, virtual private networks (VPN), encryption and passwords.

Consider next an example involving an emergency request for assistance transmitted using a mobile device. In such a case, the emergency request includes an authorization for a recipient to access the location of the mobile device. In one embodiment, the authorization expires after a predetermined period of time has lapsed. During the predetermined time period, access to the location information is unrestricted. In one embodiment, the location information is released using a public key infrastructure (PKI). PKI includes a public key and a private key and access to both is required for decoding the encrypted message. PKI, in one embodiment, allows an emergency service provider to access location information. In one embodiment, the mobile device is registered with an authorized service provider which has independent access to a valid authorization, thereby allowing access to the location information.

Consider next, exemplary applications based on a peer-to-peer relationship between a mobile device and a second (or monitoring) device. In these cases, a mobile device (first device) contacts a peer with request for location information of a second device. In various embodiments, the location information is provided on a one-time-only basis or on a scheduled (periodic) basis. In one embodiment, the mobile device is programmed to release the location information to a specified second device for a predetermined window of time. In one embodiment, the location information is transmitted from the mobile device using BLUETOOTH® security protocols.

One embodiment of the present subject matter provides notification when a mobile device is located within a specified distance of the second device. In one embodiment, the notification is provided when a specified distance is exceeded. The notification may be provided by an audible or visual signal to any of the mobile device, the second device, or to a third device. In one embodiment, the mobile device communicates with the second device and requests notification when location information indicates that the range is greater than or less than a predetermined value (within range or out of range). Access to the location information may be provided on a one-time-only basis or on a scheduled (periodic) basis. In one embodiment, the mobile device is programmed to release the location information to a specified second device for a predetermined window of time. In one embodiment, the location information is transmitted from the mobile device using BLUETOOTH® security protocols. In one embodiment, the update time interval is established by one peer and updated location information is communicated periodically. The interval relates to the frequency of updating tracking information and in one embodiment, the interval is user selectable by means of hardware or software situated at either end of the communication link. In one embodiment, location information derived from a network-based location determining section provides an approximate location for greater distances and provides increased accuracy information for smaller distances.

Consider next, exemplary applications based on a master-slave relationship between a mobile device and a compatible second (or monitoring) device. In the master-slave relationship, the master has authority to control the operation of the slave. In such a case, the security methods presented earlier with regard to peer-to-peer embodiments may be implemented. In one embodiment, access authorization is established on-line using a wired or wireless Internet connection, as described relative to FIG. 10. In one embodiment, a BLUETOOTH®-compatible transceiver may allow tracking of location within the effective communication range of BLUETOOTH®. In one embodiment, a user-controlled switch on the mobile device places the mobile device in a “set” mode which allows subsequent location information to be transferred via BLUETOOTH® or other wireless communication technology.

The master device may contact a slave device and request location information. In one embodiment, the location information is provided on a one-time-only basis or on a scheduled (periodic) basis. In one embodiment, the slave device releases the location information to the master for a predetermined window of time. In one embodiment, the location information is transmitted using BLUETOOTH® security protocols.

The master device may contact the slave device and request notification when location information indicates that range information is greater than, or less than, a predetermined value. In one embodiment, location information is provided on a one-time-only basis or on a scheduled (periodic) basis. In one embodiment, the slave device releases the location information to a specific destination for a predetermined window of time. In one embodiment, one device sets an update time interval and updated location information is communicated periodically. In one embodiment, network-based location information provides approximate location information for greater distances and provides increased accuracy information for smaller distances. In one embodiment, location information is transmitted using BLUETOOTH® security protocols.

Consider next, exemplary applications based on a master-slave relationship between a mobile device and a dissimilar second (or monitoring) device. For example, consider a cellular telephone communicating with a BLUETOOTH®-GPS automobile based system. In such a case, a protocol translator handles the interchange between different communication protocols, different security protocols, different data structures and different data formats. The protocol translator, in one embodiment, includes a central response center. Requests for location information are executed and translation is performed using business rules.

Consider next, a non-emergency commercial use of location information. In such a case, a user of a mobile device may send semi-anonymous location information to a commercial enterprise to request directions or other assistance. The semi-anonymous location information may include an approximate location, a reduced accuracy location or truncated location information. For example, where a longitudinal location would otherwise be specified as 91.4567, a truncated location may provide that the location is 91.45. In one embodiment, a non-anonymous (i.e., known) trust relationship is established. For example, a BLUETOOTH® equipped device may reveal a serial number when communicating. Knowledge of a BLUETOOTH® device serial number does not jeopardize the privacy of a user because the range of BLUETOOTH®-only communications does not extend beyond a limited range. In one embodiment, the network-based location information technology implements privacy measures such as those found on the Internet or using e-commerce, for example, secure sockets, virtual private network (VPN), encryption and passwords.

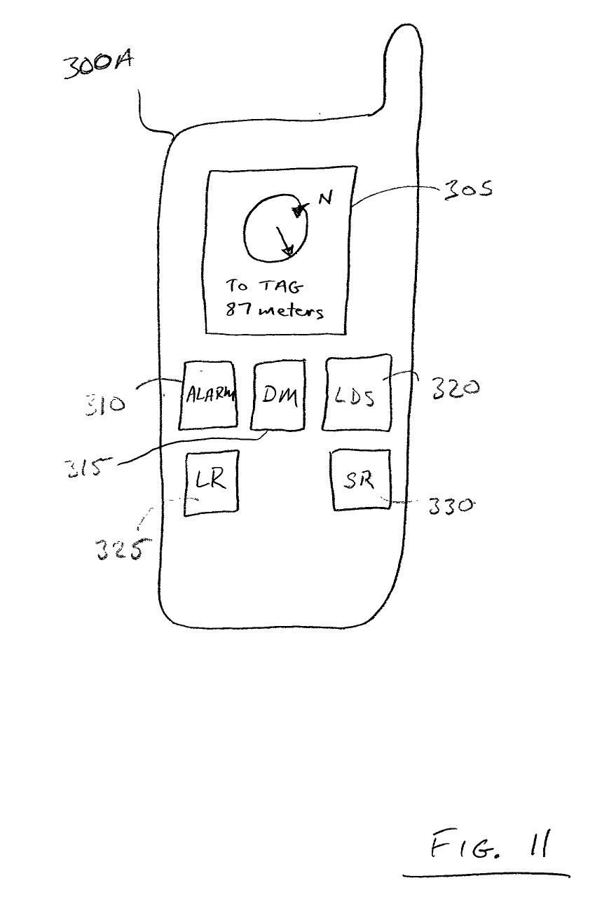

The second device may be mobile or relatively stationary. In one embodiment, as a portable device, the second device includes a display screen that indicates directional information. FIG. 11 depicts one embodiment of second device 300A. Display screen 305 provides visual imagery for a variety of programmed functions. In the figure, screen 305 represents a directional compass face with a northerly direction indicated by a bug, or triangle, and a direction to a target (or tag) indicated by an arrow. Direction from a target may also be displayed. The screen also provides textual information indicating that the target, in this example, is 87 meters away from device 300A. Device 300A, in this embodiment, also includes annunciator or alarm module 310, electronic compass module 315, location determining section 320, long range communication module 325 and short range communication module 330. In the figure, device 300A includes a cellular telephone.

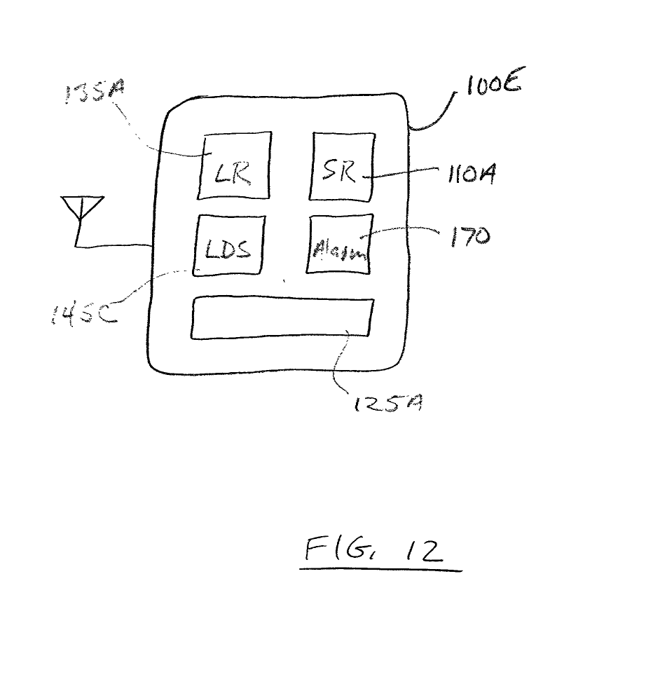

FIG. 12 illustrates mobile device 100E. As used herein, the term mobile device, tag and target are used interchangeably. In the figure, device 100E is a blind device in that it does not include a visual display and includes location determining section 145C, long range communication module 135A, short range communication module 110A, alarm 170 and user I/O section 125A.

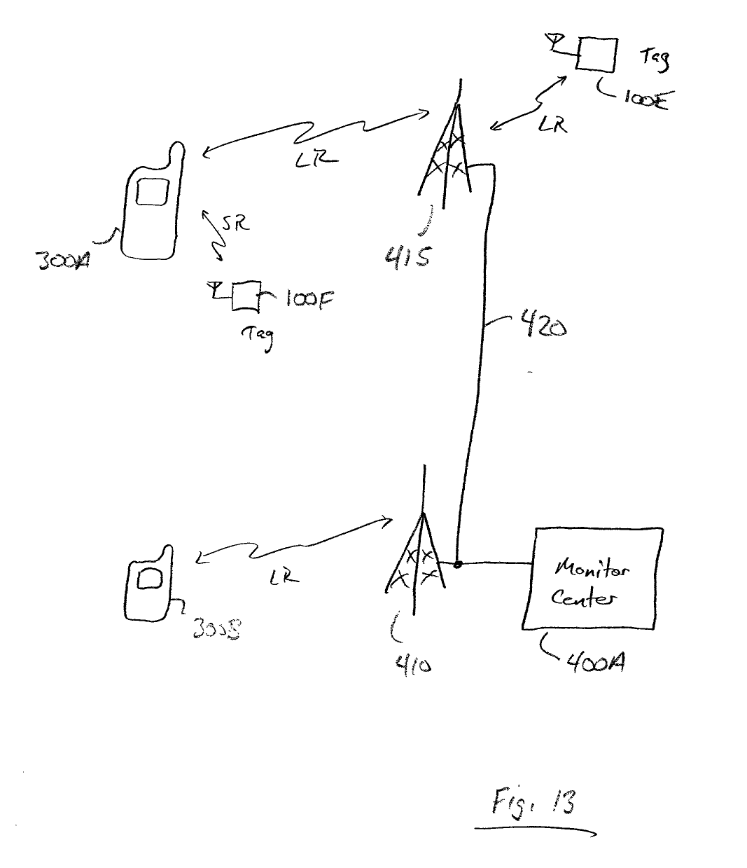

FIG. 13 depicts second device 300A communicating with mobile devices 100E and 100F. In the figure, communications with mobile device 100E are conducted using long range communication networks and cellular telephone tower 415 and communications with mobile device 100F are conducted using short range communications. Location information from mobile devices 100E and 100F are accessible from monitoring center 400A via network connection 420. In addition, second device 300B has access to mobile devices 100E and 100F. Second devices 300A and 300B may be two-way pagers adapted for response messaging. Response messaging entails receiving a pager message and replying using any of a plurality of multiple-choice responses. In one embodiment, second devices 300A and 300B include programmable two-way paging devices such as the Motorola PageWriter™ 2000 and functions as both a two-way pager and a handheld co one embodiment, second devices 300A and 300B include analog or digital cellular telephones and may operate using PCS, code division multiple access (CDMA), time division multiple access (TDMA) or others. The cellular telephone may include remotely programmable functions and provide graphical or textual displays.

In various embodiments of second devices 300A (or 300B), security passwords may be entered by accessing user-operable keys. In one embodiment, the security password is entered by speaking a word aloud and using voice recognition technology, word recognition or a combination of voice and word recognition technologies. In one embodiment, a predetermined order of pressing selected keys provides the equivalent of a security code.

In one embodiment, the second device includes a handheld computer or PDA adapted for communicating using a wireless network. Examples of this PDA's includes the PalmPilot™ or Palm series of devices manufactured by 3-COM™.

In one embodiment, a second device includes a plug-in module that connects to a serial port, USB ports or other wired port. In addition, infrared or other short range wireless networks may connect a separate module to the second device. In one embodiment, the second device includes hardware and software to serve as a long range, bi-directional, wireless modem.

In one embodiment, a program executing on the second device determines relative distance and direction between the second device and mobile device 100E. The program is adapted to operate continuously to update the relative distances and directions as one or more of the two devices move. In one embodiment, monitoring center 400A calculates relative distances and directions and uplinks the information to second device 300A.

In one embodiment, location information is recorded in a memory of second device 300A for later recall.

In one embodiment, second device 300A is coupled to a portable communication device such as a pager, a cellular telephone, a personal digital assistant or other communication device. In one embodiment, second device 300A is line powered. Second device 300A includes a receiver coupled to a processor. Second device 300A, in one embodiment, includes a display, speaker, or vibratory mechanism to indicate that a particular predetermined range has been exceeded.

Long Range Wireless Communication Network

In one embodiment second device 300A is equipped with a bi-directional, long range communication module 325. For example, in one embodiment, long range communication module 325 includes a cellular telephone transceiver. In one embodiment, tag 100E is equipped with compatible, bi-directional, long-distance module 135A.

In one embodiment, second device 300A incorporates long range communications module 325 to connect to a long range, bi-directional network. Module 325 is compatible with a long range wireless communication networks such as a cellular network, a satellite network, a paging network, a narrowband PCS, a narrowband trunk radio or other wireless communication network. In one embodiment, long range communication module 325 can communicate with any combination of such networks.

In one embodiment, the long range wireless network includes a cellular communication network. In one embodiment, the long range wireless network includes a paging network. In one embodiment the long range wireless network includes a satellite network. In one embodiment the long range wireless network includes a wideband or narrowband PCS network. In one embodiment the long range wireless network includes a wideband or narrowband trunk radio module. Other networks are possible without departing from the present system. In one embodiment, the long range communication module 325 includes transceivers compatible with multiple communication network systems, such as, for example, a cellular module and a two-way paging module. In such embodiments, the system may preferentially communicate using one form of network communications over another and may switch depending on a variety of factors such as available service, signal strength, or types of communications being supported. For example, the cellular network may be used as a default and the paging network may take over once cellular service is either weak or otherwise unavailable. Other permutations are possible without departing from the present system.

The long range wireless network employed may be a consumer or proprietary network designed to serve users in range of the detection system, including, but not limited to, a cellular network such as analog or digital cellular systems employing such protocols and designs as Cellular Digital Packet Data (CDPD), Code-division Multiple Access (CDMA), Global System for Mobile Communications (GSM), Personal Digital Cellular (PDC), Personal Handyphone System (PHS), Time-division Multiple Access (TDMA), FLEX™ (Motorola), ReFLEX™ (Motorola), iDEN™ (Motorola), TETRA™ (Motorola), Digital Enhanced Cordless Telecommunications (DECT), DataTAC™, and Mobitex™, RAMNET™ or Ardis™ or other protocols such as trunk radio, Microburst™, Cellemetry™, satellite, or other analog or digital wireless networks or the control channels or portions of various networks. The networks may be proprietary or public, special purpose or broadly capable. However, these are long range networks and the meaning imposed herein is not to describe a premises or facility based type of wireless network.

The long range wireless network may employ various messaging protocols. In one embodiment Wireless Application Protocol (WAP) is employed as a messaging protocol over the network. WAP is a protocol created by an international body representing numerous wireless and computing industry companies and is designed to work with most wireless networks such as CDPD, CDMA, GSM, PDC, PHS, TDMA, FLEX, ReFLEX, iDEN, TETRA, DECT, DataTAC, and Mobitex and also to work with some Internet protocols such as HTTP and IP. Other messaging protocols such as iModeM™, Wireless Markup Language (WML), Short Message Service (SMS) and other conventional and unconventional protocols may be employed without departing from the design of the present embodiment.

As an example, these long range communication protocols described above may include, but are not limited to, cellular telephone protocols, one-way or two-way pager protocols, and PCS protocols. Typically, PCS systems operate in the 1900 MHZ frequency range. One example, known as Code-division Multiple Access (CDMA, Qualcomm Inc., one variant is IS-95) uses spread spectrum techniques. CDMA uses the fall available spectrum and individual messages are encoded with a pseudo-random digital sequence. Another example, Global Systems for Mobile Communications (GSM), is a digital cellular system and allows eight simultaneous calls on the same radio frequency. Another example, Time Division Multiple Access (TDMA, one variant known as IS-136) uses Time-division Multiplexing (TDM) in which a radio frequency is time divided and slots are allocated to multiple calls. TDMA is used by the GSM digital cellular system. Another example, 3G, promulgated by the ITU (International Telecommunication Union, Geneva, Switzerland) represents a third generation of mobile communications technology with analog and digital PCS representing first and second generations. 3G is operative over wireless air interfaces such as GSM, TDMA, and CDMA. The EDGE (Enhanced Data rates for Global Evolution) air interface has been developed to meet the bandwidth needs of 3G. Another example, Aloha, enables satellite and terrestrial radio transmissions. Another example, Short Message Service (SMS), allows communications of short messages with a cellular telephone, fax machine and an IP address. Messages are limited to a length of 160 alpha-numeric characters. Another example, General Packet Radio Service (GPRS) is a standard used for wireless communications and operates at transmission speeds far greater than GSM. GPRS can be used for communicating either small bursts of data, such as e-mail and Web browsing, or large volumes of data.

In one embodiment, a long range communication protocol is based on oneway or two-way pager technology. Examples of one way pager protocols include Post Office Code Standardization Advisory Group (POCSAG), Swedish Format (MBS), the Radio Data System (RDS, Swedish Telecommunications Administration) format and the European Radio Message System (ERMES, European Telecommunications Standards Institute) format, Golay Format (Motorola), NEC-D3 Format (NEC America), Mark IV/VI Formats (Multitone Electronics), Hexadecimal Sequential Code (HSC), FLEX™ (Motorola) format, Advanced Paging Operations Code (APOC, Philips Paging) and others. Examples of two-way pager protocols include ReFLEX™ (Motorola) format, InFLEXion® (Motorola) format, NexNet® (Nexus Telecommunications Ltd. of Israel) format and others.

Other long range communication protocols are also contemplated and the foregoing examples are not to be construed as limitations but merely as examples.

Short Range Wireless Communication FIG. 13 illustrates communications between second device 300A and tag 100F. In one embodiment, second device 300A includes a short range wireless communication module 330. Module 330 is adapted for short range, bi-directional, wireless network communications. In one embodiment, tag 100F or tag 100E includes a short range communication module 110A compatible with module 330. In one embodiment, tag 100E includes a short range communication module 110A and no long range communication module 135A.

In one embodiment, the short range communication module includes a spread spectrum frequency hopping transceiver. This transceiver may communicate using a protocol compatible with BLUETOOTH®. BLUETOOTH® refers to a wireless, digital communication protocol using a low form factor transceiver that operates using spread spectrum frequency hopping at a frequency of around 2.45 GHz.

BLUETOOTH® is a trademark registered by Telefonaktiebolaget LM Ericsson of Stockholm, Sweden and refers to technology developed by an industry consortium known as the BLUETOOTH® Special Interest Group. BLUETOOTH® operates at a frequency of approximately 2.45 GHz, utilizes a frequency hopping (on a plurality of frequencies) spread spectrum scheme, and as implemented at present, provides a digital data transfer rate of approximately 1 Mb/second. Future implementations are expected to include higher data transfer rates. In one embodiment, the present system includes a transceiver compatible with BLUETOOTH® technical specification version 1.0, herein incorporated by reference. In one embodiment, the present system includes a transceiver in compliance with standards established, or anticipated to be established, by the BLUETOOTH Special Interest Group.

In one embodiment, the present system includes a transceiver in compliance with standards established, or anticipated to be established, by the Institute of Electrical and Electronics Engineers, Inc., (IEEE). The IEEE 802.15 WPAN standard is anticipated to include the technology developed by the BLUETOOTH® Special Interest Group. WPAN refers to Wireless Personal Area Networks. The IEEE 802.15 WPAN standard is expected to define a standard for wireless communications within a personal operating space (POS) which encircles a person. Other IEEE standards, including others in the 802 series, are also contemplated.

In one embodiment, module 110A includes a wireless, bi-directional, transceiver suitable for short range, omni-directional communication that allows ad hoc networking of multiple transceivers for purposes of extending the effective range of communication. Ad hoc networking refers to the ability of one transceiver to automatically detect and establish a digital communication link with another transceiver. The resulting network, known as a piconet, enables each transceiver to exchange digital data with the other transceiver. According to one embodiment, BLUETOOTH® involves a wireless transceiver transmitting a digital signal and periodically monitoring a radio frequency for an incoming digital message encoded in a network protocol. The transceiver communicates digital data in the network protocol upon receiving an incoming digital message. According to one definition, and subject to the vagaries of radio design and environmental factors, short range may refer to systems designed primarily for use in and around a premises and thus, the range generally is below a mile. Short range communications may also be construed as point-to-point communications, examples of which include those compatible with protocols such as BLUETOOTH®, HomeRF™, and the IEEE 802.11 WAN standard (described subsequently). Long range, thus, may be construed as networked communications with a range in excess of short range communications. Examples of long range communication may include, Aeris MicroBurst cellular communication system, and various networked pager, cellular telephone or, in some cases, radio frequency communication systems.

In the event that transceiver includes a transceiver compatible with BLUETOOTH® protocol, for example, then the associated device may have sufficient range to conduct bidirectional communications over relatively short range distances, such as approximately 10 to 1,000 meters or more. In some applications, this distance allows communications throughout a premise.

The network module may include a separate, integrated or software based short range bi-directional wireless module. The short range network may be based upon HomeRF™, IEEE 802.11, BLUETOOTH®, or other conventional or unconventional protocols. However, these are short range networks and the meaning imposed herein is to include premises and facility based wireless networks and not to describe long range networks such as cellular telephone networks used to communicate over long-distances. Such a system may include programmable, or automatically selecting, electronic circuitry to decide whether to conduct communications between second device 300A and tag 100E using the short range module or the long range network module. In one embodiment the system may employ different portions of the network to provide short range or long range network connections, depending on the distance between the second device 300A and tag 100E. In one such embodiment, the network automatically adjusts for different required transmission distances.

In one embodiment, the transceiver is compatible with both a long range communication protocol and a short range communication protocol. For example, a second device located a long distance away, such as several miles, may communicate with the tag using a cellular telephone compatible with the long range protocol of the tag.

Other short range communication protocols are also contemplated and the foregoing examples are not to be construed as limitations but merely as examples.

The Tag

FIG. 12 illustrates one embodiment of tag 100E. In one embodiment, second device 300 is in wireless communication with tag 100E for the purpose of tracking or finding the tag 100E. The communications between second device 300A and tag 100E may include a short range wireless network as described herein, a long range wireless network as described herein, or both. Communications may be continuous, intermittent, on a schedule, or based upon preset conditions.

Tag 100E may be attached to, or carried by, an object, person or animal. In one embodiment, second device 300 receives wireless information as to the distance between device 300 and tag 100E.

In one embodiment, when the distance between second device 300 and tag 100 exceeds a predetermined distance (a specific range), then an associated alarm is triggered at tag 100E, second device 300, or both. In one embodiment, the alarm includes an audible alarm. In one embodiment, the alarm includes a visual indication. In one embodiment, the alarm includes a vibration function. In one embodiment, the visual indication includes text information.

In one embodiment, the tag 100E transmits location information relative to the location of second device 300 or a fixed location. In one embodiment, the location information includes a geographic position expressed by latitude and longitudinal coordinates. The location information provided to second device 300 may include directional, distance, and velocity information, which may assist in locating the object, person or animal carrying tag 100E.

In one embodiment, the present system uses RF transmissions for monitoring a linear distance between two devices. Tag 100, in one embodiment, includes a portable module and second device 300 may be either mobile or stationary module.

In one embodiment, tag 100 includes a battery-operated transmitter and a microprocessor. The transmitter broadcasts a signature, which varies as a function of the distance from the device. In one embodiment, tag 100 includes a user operable range setting control, which allows the distance to be calibrated. In one embodiment, tag 100 includes a transceiver.

In one embodiment, location information may be recorded in a storage memory of tag 100 for later recall.

In one embodiment, tag 100 uses an RF signal to set an allowable range from second device 300.

In one embodiment, the tag 100 includes a GPS-based vehicle tracking system.

In one embodiment, tag 100 may function as a second device and second device 300 may function as a tag 100.

In one embodiment, more than one tag 100 is associated with one second device 300. In one embodiment, multiple tag 100 devices are of different types.

Distance and Direction Calculation

Various means can be employed to determine the distance between the first and second device, including:

a) range may be determined on the basis of signal strength. Signal strength drops as the cube of the distance and can be used to determine the range. In addition, a directional antenna may be utilized to determine direction.

b) range may be determined using discrete global position information (GPS) modules. Either second device 300, tag 100 or both includes a GPS receiver and a calculation is performed by the processor of either one or both devices to determine the range between the devices. The processor of either one or both devices can be used to determine direction between the devices.

c) range may be determined using timing differences (each device has transceiver). A clock signal is used to determine the distance between each device. For example, a clock operating in one device is monitored while a signal is exchanged between the first and second device. Relative distance is based on the elapsed transit time for the signal.

d) by using an independent directional device, such as an electronic compass which indicates a northerly direction (magnetic or true), second device 300 may indicate relative direction, or bearing, to tag 100.

Setting a Range

In one embodiment, tag 100 is affixed to, or carried by, a first object or first person and second device 300 is affixed to a second object or carried by a second person. The distance between the first and second objects is then monitored and displayed, or annunciated, at the second object or to the second person. In one embodiment, if the distance exceeds a predetermined value, then an audible, vibratory, or visual message is presented using second device 300.

In one embodiment, tag 100 has a characteristic signature, or identification information, and second device 300 is responsive to this signature. Second device 300 selectively monitors the distance between the first and second device. In one embodiment, second device 300 includes a transceiver compatible with tag 100. Second device 300 can monitor the RF signal from a single predetermined tag 100 and ignore other devices or tags in the area. The process may include security functions.

In one embodiment, the range at which an alarm is sounded or triggered, that is, the trigger range, may be set manually or automatically. In alternative embodiments, the trigger range may be set using tag 100 or second device 300. In one embodiment, the trigger range is set by physically placing tag 100 at a desired distance and actuating a button on the device or entering a voice command. The desired distance is then associated with characteristic signal strength, or other measurable value, which then establishes a perimeter beyond which an alarm is sounded or a trigger signal is generated. If the distance between tag 100 and second device 300 exceeds the trigger range, then, in various embodiments, different methods may be executed. For example, in one embodiment, the RF range is increased and communications between tag 100 and second device 300 is reestablished. As another example, in one embodiment, tag 100 sends location information to second device 300. The location information may include range and bearing or GPS coordinates. In one embodiment, an alarm is sounded on second device 300 showing the location of tag 100. The alarm may include a sound, a light, a text message, or a vibratory message. As another example, a network connection to a wide, or narrow, area communication network may be used to determine the location of tag 100.

In one embodiment, the trigger distance is established by physically moving tag 100 to the allowed perimeter distance and adjusting the signal transmission strength of the transmitter or the sensitivity of the receiver until a predetermined level is reached which then generates an alarm at second device 300. Alternatively, preset signal strengths associated with various distances can be used. In various embodiments, either the receiver or the transmitter is adjusted.

In one embodiment, when the devices indicate that the trigger range has been exceeded then the transmitter output signal is raised. In one embodiment, the RF range is not at the maximum at the perimeter of the selected range.

Similar principles may be used to track items, objects, or persons that are normally out-of-range and that move into RF range. For example, two people in a dense crowd can locate each other using the present technology. If each person carries a BLUETOOTH®-equipped telephone, then this technology allows no-fee voice or data communication between the telephones rather than cellular networkbased communications.

Directional Module

In one embodiment, second device 300 includes directional module 315. Directional module (DM) 315, in one embodiment, includes a compass to indicate relative orientation of second device 300. In various embodiments, DM 315 provides information relative to true north or magnetic north. In one embodiment, DM 315 provides a signal to generate data displayed on screen 305. In one embodiment, DM 315 provides a navigation bearing to a selected target or tag. In one embodiment, second device 300 uses mapping solutions and directions based upon maps. In one embodiment, the DM 315 includes programming and a module operable with a PDA device. In one embodiment, the DM 315 is integrated into a battery pack adapted for use with second device 300. In one embodiment, the second device 300 includes a cellular telephone coupled to an electronic compass. In one embodiment, the DM 315 operates independently of a network device. In one embodiment, second device 300 both transmits a first electronic beacon signal and receives a second electronic beacon signal. Thus, a pair of second devices 300 can be used to locate each other. In one embodiment, the second device 300 and tag 100 include cellular telephone transceivers and thus, each is capable of conducting a cellular telephone call with other devices or each other.

Display

In one embodiment, second device 300 includes display 305. On display 305, north may be indicated by a bug or triangle appearing around the periphery of a compass rose. In one embodiment, the direction to tag 100 may be indicated in similar fashion using display 305. In one embodiment, second device 300 receives location information from tag 100. The location information may include latitude and longitude data and may be updated periodically as the relative locations of the devices change. Second device 300 may display relative distance and direction. In one embodiment, a user of second device 300 can orient the device to align with magnetic or true north and by using the displayed compass, navigate to the location of tag 100.

Response Center

In one embodiment there is a monitor center 400A is in communication with either or both the second device 300 and the tag 100. In one embodiment, monitor center 400 relays information between tag 100 and second device 300 and provides a data or protocol exchange or translation function.

In one embodiment, monitor center 400 provides data representing a vicinity map for display on second device 300. In one embodiment, monitor center 400 provides landmark information to second device 300. A landmark may be public location, a park, a gas station, a bank, an automatic teller machine (ATM) or other facility or location.

In one embodiment, the monitor center 400 provides navigation information to second device 300 to allow a user of second device 300 to navigate from the current location to a user selected landmark. Navigation information may include, for example, a fixed point to which the distance and direction display on second device 300 guides the user. Navigation information, in one embodiment, includes one or more maps and may include a text description, including en route visual landmarks.

In one embodiment, monitor center 400 provides commercial information regarding businesses to the second device 300.

In one embodiment, monitor center 400 provides emergency assistance to second device 300. Emergency assistance may include tracking information regarding tag 100 or it may include guiding responding agencies to second device 300, tag 100 or both second device 300 and tag 100. In one embodiment, emergency response personnel may carry a second device 300 for purposes of locating tag 100.

Examples of Application Embodiments

Personal Tag Item

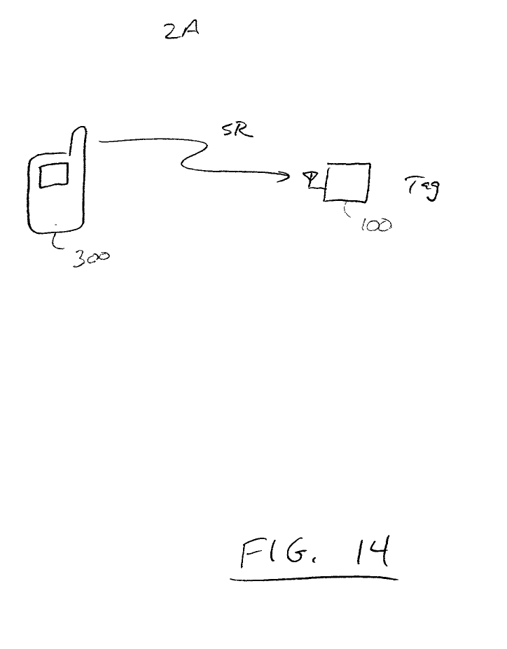

FIG. 14 illustrates an embodiment of the present technology. In the figure, a user is carrying second device 300 and has established an association with tag 100 to track the location of a personal item connected to tag 100. Second device 300 is in short range communication with tag 100. The location of tag 100 is monitored using a short range bidirectional link according to one of the methods described herein. In one embodiment, when tag 100 is located beyond a preset range, then an alarm is sound on tag 100, using second device 300 or both tag 100 and second device 300.

In one embodiment, a GPS location module in second device 300 and a GPS location module in tag 100 work cooperatively to establish a range or bearing. When tag 100 is located beyond a preset range, then an alarm sounds or is otherwise indicated. In addition, based upon location coordinates, tag 100 is able to transmit location information, velocity and bearing to second device 300. In one embodiment, second device 300 calculates location information, velocity (that is, speed and direction) based upon coordinates transmitted from tag 100. Location information, velocity and direction may be used to assist second device 300 in recovering tag 100. In addition, second device 300 may include a direction module 315 and a display 305 to determine relative directions and present, to the user, a display of relative direction.

High Value Courier

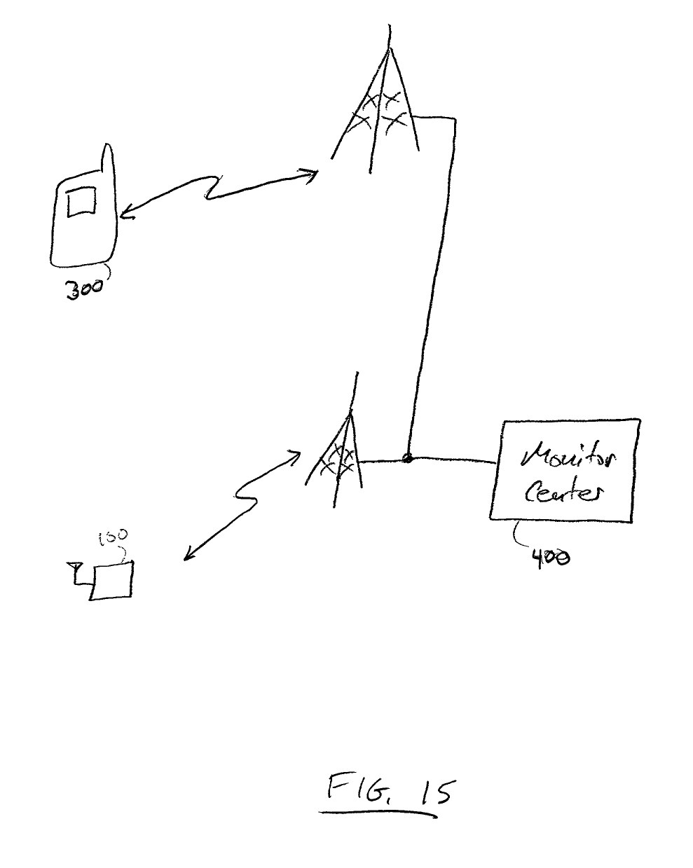

FIG. 15 illustrates an embodiment where a courier is carrying second device 300 and tag 100 is placed in the parcel containing the valuable contents. In one embodiment, a long range bi-directional communication module 325 and 135A is included in second device 300 and tag 100, respectively. These communication modules enable exchange of location information between second device 300 and tag 100 at ranges beyond a short range. In one embodiment, long range communications allows for the retrieval of the valuable contents associated with tag 100.

In one embodiment, tag 100, second device 300, or both devices can report alarm information to monitor center 400. Monitor center 400 is in communication with emergency personnel and can dispatch assistance to the site of the second device 300 as well as tag 100.

Find a Friend

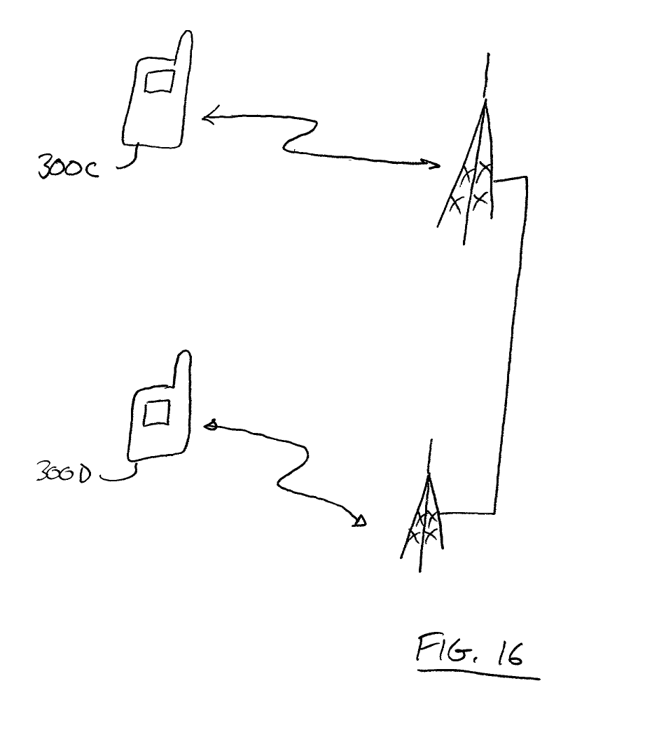

FIG. 16 illustrates an application utilizing a second device 300C and second device 300D, each carried by a different person. In one embodiment device 300C places a cellular telephone call to device 300D, using long range communication modules of the respective devices, and activating the tracking feature. In one embodiment device 300C and device 300D establish communications using short range communication modules of the respective devices and activate a tracking feature. In one embodiment, when device 300C and device 300D are in communication with each other, a security feature is exchanged to allow tracking of location information. In one embodiment, the security feature includes an authorization code to allow release of location information. In one embodiment, they are able to do this as a software feature without ever connecting to each other.

Once the two second device 300s are associated for tracking purposes, other applications are enabled. For example:

a) one person is able to track the location of another on a continuous basis, a scheduled basis, an event driven basis (such as when one person pushes a help button), or upon a query from the other second device 300 to the other.

b) a pair of friends may know when they are in short range communications range, thus allowing bidirectional voice communications without incurring cellular telephone network charges.

c) a parent can determine when a child has strayed too far away at a park or other location and find them if they did.

Responding Agency

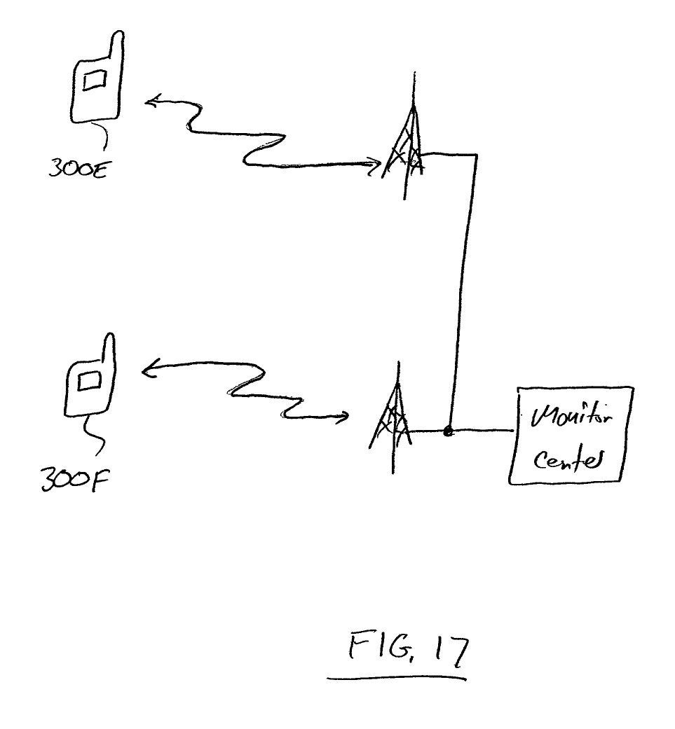

FIG. 17 illustrates an embodiment where emergency personnel, such as a police officer, carries second device 300F on their person to find second device 300E or tag 100. In one embodiment, monitor center 400 provides enhanced location services. In one embodiment, second device 300E transmits a request for assistance which includes a security authorization for monitor center 400 to track location of device 300E. Monitor center 400 forwards the emergency request to device 300F, along with the security authorization, to allow simultaneous tracking of second device 300E. In one embodiment, device 300F is pre-authorized to track location of device 300E without need of an exchange between device 300E and device.

In one embodiment, short range communications module assists the emergency personnel in locating second device 300E.

Receive Directions

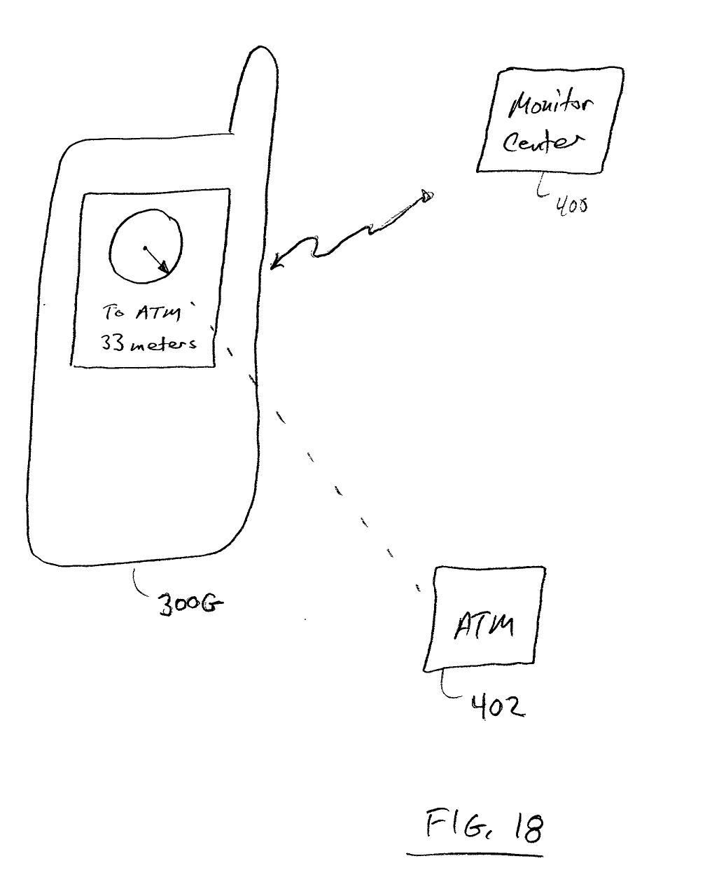

FIG. 18 illustrates an embodiment wherein second device 300G queries monitor center 400 with a request for information for a nearby, or specific, location. In the figure, ATM 402 is the target destination. Monitor center 400 provides location information to second device 300G to allow a user to display navigation information directed to finding ATM 402. In one embodiment, the display of device 300G indicates direction and distance to ATM 402.

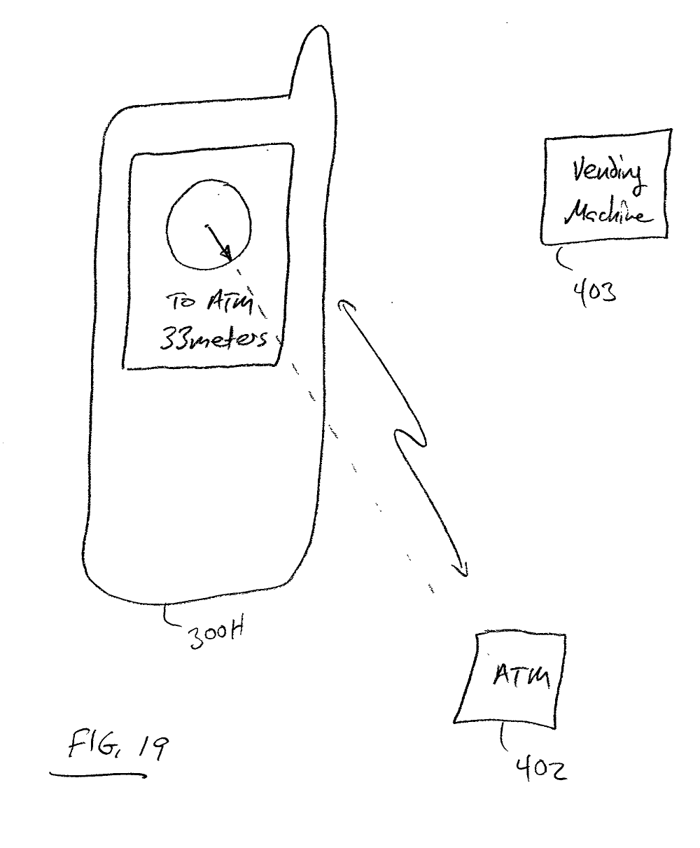

FIG. 19 illustrates an embodiment of the present system used to discover a landmark or service. In one embodiment, device 300H transmits a request to determine if nearby compatible devices exist. In one embodiment, the request is for a nearby compatible device of a particular type such as, for example, ATM 402 or vending machine 403. Upon receiving a wireless transmission from device 300H one or more of the receivers, here illustrated by vending machine 403 and ATM 402, sends a reply. The reply may include directional information to assist in finding, for example, ATM 402. In the embodiment shown, device 300H presents a graphical image depicting the range and bearing to the selected receiver.

In one embodiment, other pertinent information about the landmark or service is available to be delivered along with the location information.

Alternative Embodiments

Other embodiments of the present subject matter are also contemplated, including, for example but not by way of limitation, those presented below.

In one embodiment, the mobile device or the second device may be of different types, for example, an additional second device, a specialized device associated with a person, vehicle, or asset or a device that reports directly to the second device.

In one embodiment, the second device provides a display that includes the direction and distance to the tags and the direction and velocity of the tags, if moving.

In one embodiment, the system includes hardware and software for a network device, such as a personal digital assistant (PDA), a pager or a cellular telephone. In one embodiment, the device determines range and bearing to (or from) another location. The location determining technology may include a global positioning system (GPS) receiver executing on the device, an electronic compass, and software or circuitry to calculate the relative distance between the device and a target location, the bearing (or direction) to or from the target location, and relative speed with respect to the target location. Velocity information, that is, direction and speed, may be generated and displayed on the device.

The information presented to the user may be in the form of range and bearing. The bearing (or direction) information may be presented using an arrow. The range (or distance) information may be presented using an arrow of varying size or weight or other means. The information presented to a user is in a form that is intuitively helpful in identifying the predetermined location. For example, the information may allow a person to travel directly to the predetermined location. In one embodiment, the information is updated dynamically based upon the relative movement of either the person or the item or both.

In one embodiment, the present subject matter includes a voice communication channel that allows a second device and a tag, or two second devices, to exchange signals representing voice. The voice communication channel may include digital data transmission using BLUETOOTH® or other wireless technology. In this manner, fees associated with traditional cellular telephone transmissions are avoided.

In one embodiment, the present subject matter allows a suitably equipped second device, or tag, to access selected wireless security system elements. For example, a second device can be used to establish a communication or control channel with a BLUETOOTH®-equipped passive infrared motion sensor as part of a security system.

In one embodiment, system are established that restrict access to location information for a tag or second device. For example, the ability to access location information, in one embodiment, requires that authorization is first granted, either explicitly or implicitly. In one embodiment, authorization to access location information is granted by a registration agency based on emergency authority such as court order or other sufficient cause. In one embodiment, access to location information is based on a grant of permission.

In one embodiment, a monitor center provides services to relay location information between second devices and mobile devices. In one embodiment, the monitor center provides a translation function. The translation function, for example, may include converting location information encoded in a first data format into a second data format. The translation format may also convert data compatible with a first transceiver into data compatible with a second transceiver where the first and second transceiver are otherwise not compatible. For example, in one embodiment, data from a tag encoded in digital format using a two-way pager equipped tag is converted using a monitor center into data compatible with a BLUETOOTH®-equipped automobile-based transceiver.

In one embodiment, the present subject matter relates to technology for managing geographical location information using wireless devices. For example, in one embodiment, the location of a portable wireless device can be remotely accessed or monitored, depending on authorization granted by the mobile device.

The present subject matter also relates to methods and systems for managing location information. For example, in some circumstances it may be desirable to reveal location information corresponding to the mobile device and in other circumstances, it may be desirable to conceal, or preclude access to, location information of the mobile device. The present subject matter manages the distribution of location information based on various parameters, including user selected criteria, the nature of the message transmitted from the first device, authorized access emergency override settings, non-user accessible configuration settings established by supervisory authority.

Consider a two element system wherein a first device is co-located with an object and a second device is carried by a person seeking the object. Remote accessibility of location information of the first device may be restricted or unrestricted. For example, in certain applications, it may be desirable to limit the distribution of location information to authorized personnel only. In one embodiment, location information of the first device may be implicitly included with a request from the first device. The request may include a distress signal, an emergency signal, a scheduled signal or other transmission. The request may be transmitted in response to a manual input or automatically according to a predetermined program. In one embodiment, the location information of the first device may be accessible after having received explicit authorization from the first device.

In one embodiment, the present subject matter includes using a first mobile device, or second device, as a stand-alone electronic compass. One embodiment of the present subject matter includes a display that indicates relative direction and a transceiver that can transmit messages and location information and also receive messages and directional information. For example, but not by way of limitation, this device can function as a navigational compass or assist a user in navigating to or from a fixed location. The device can receive location information from remote sources includes a fixed target location or a monitor center. In addition, the device can transmit a homing signal, or beacon, to allow others to find the device.

When the present subject matter is used in conjunction with a second device, that is a tag and a second device or a pair of second devices, then additional functions are available in one embodiment. For example, if the second device is stationary, then in addition to aforementioned functions, the second device can be adapted to transmit location information or directions to the mobile device. The directions may provide instructions for navigating to or from a fixed location or the second device's location (the second device's location may be self-determined or generated). In addition, the second device can be adapted to receive directions to or from the mobile device or to or from a fixed location. Furthermore, the second device can interrogate the mobile device to receive location information and display range, closing speed, estimated time of arrival or other data.

In one embodiment, the first device transmits location information based on authorization of the second device or based on the nature of the transmitted message.

In one embodiment, the location of the mobile device can be identified or remain anonymous (based on entries made using the mobile device or based on entries made using a second device. In one embodiment, the location finding technology for the mobile device resides in the mobile device, in a communication network (long range or short range) or in a combination of the device and a communication network.

In one embodiment, access to location information from a mobile device is granted for a limited period of time. In other words, for times before access is granted, and for times after the period has transpired, a remote device (second device, monitoring center, or other entity) has no authority to access location information and is thus precluded from learning the whereabouts of the mobile device.

In one embodiment, the present subject matter operates in conjunction with remote monitoring of location information. In other words, a remote user can access location information of a mobile device using a web based browser or other device coupled to a LAN or WAN (such as the Internet).

In one embodiment, the mobile device transmits a message with an implicit authorization to access location information. Examples of implicit requests include “where is the nearest ATM?” or “I am having an emergency-come find me.” In such cases, the mobile device and the second device may be related by a peer-to-peer relationship or a master-slave relationship between mobile device (slave) and secondary device (master). Location information may reside in network-based location technology, network-based and device-based location technology (combination), or in mobile device-based location technology.

In one embodiment, the mobile device sends a message with an explicit authorization to access location information. An examples of an explicit request includes “here is my location; where are you?” In such cases, the mobile device and the second device may be related by a peer-to-peer relationship or a master-slave relationship between mobile device (slave) and secondary device (master). Location information may reside in network-based location technology, network-based and device-based location technology (combination), or in mobile device-based location technology.

In one embodiment, the secondary device (either mobile or stationary) sends a message with an explicit request to access location information of a mobile device. The mobile device may grant explicit authorization to access location information or the mobile device may not have granted explicit authorization (and thus, the operation is that of an emergency “find” operation). In such cases, the mobile device and the second device may be related by a peer-to-peer relationship or a master-slave relationship between mobile device (slave) and secondary device (master). Location information may reside in network-based location technology, network-based and device-based location technology (combination), or in mobile device-based location technology.

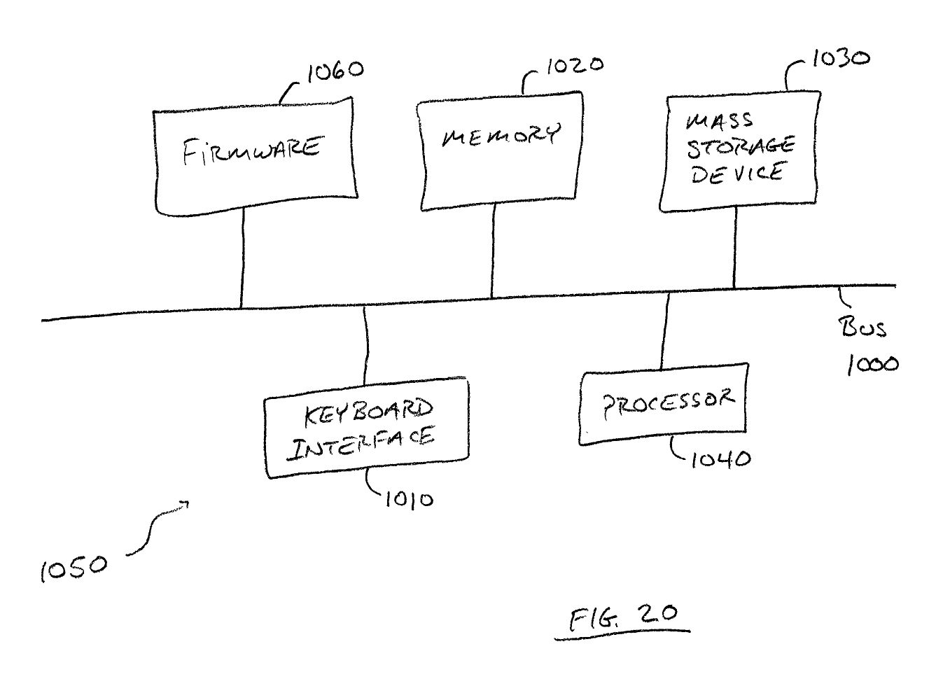

FIG. 20 includes a block diagram of computer system 1050, according to one embodiment of the present subject matter. Computer system 1050 includes bus 1000, keyboard interface 1010, external memory 1020, mass storage device 1030, processor 1040 and firmware 1060. Bus 1000 may be a single bus or a combination of multiple buses. Bus 1000 provides communication links between components in the system. Keyboard interface 1010 may be a dedicated device or may reside in another device such as a bus controller or other controller. Keyboard interface 1010 allows coupling of a keyboard to the system and transmits signals from a keyboard to the system. External memory 1020 may comprise a dynamic random access memory (DRAM) device, a static random access memory (SRAM) device, or other memory devices. External memory 1020 stores information from mass storage device 1030 and processor 1040 for use by processor 1040. Mass storage device 1030 may be a hard disk drive, a floppy disk drive, a CD-ROM device, or a flash memory device or the like. Mass storage device 1030 provides information to external memory 1020. Firmware 1060 is nonvolatile memory programmed with data or instructions. Examples of firmware 1060 include, but are not limited to, read-only memory (ROM), programmable read-only memory (PROM), and electrically erasable programmable read-only memory (EEPROM), and flash memory.

The Network Module

The network module may be of several different designs. For example, in one embodiment it includes a response messaging capable two-way pager. This is service where a two-way pager receives a message and optional multiple-choice responses. The user can select the appropriate responses. Such a design may be adapted to provide basic control options related to the system.

In one embodiment, the network module includes a programmable two-way paging device such as the Motorola Page Writer™ 2000. This is a class of devices that acts as both a two-way pager and a handheld computer also known as a PDA (Personal Digital Assistant).

In one embodiment, the network module includes a cellular telephone. The cell phone may be analog or digital in any of the various technologies employed by the cell phone industry such as PCS, or CDMA, or TDMA, or others. The cell phone may have programmable capability such as is found in a Nokia™ 9000 series of devices.

In embodiments where the user employs standard or adapted paging or cell phones as their network module, security passwords may be entered by using numeric or other keys on a phone. In one embodiment, the security password may be entered by speaking words. In this embodiment, the system may use word recognition, voice recognition or a combination of these technologies. In the embodiment of a pager, a distinct order of pressing certain keys could provide the equivalent of a security code. For example, 3 short and 1 long on a certain key; or once on key ‘a’, once on key ‘b’, and once more on key ‘a’.

In one embodiment, the network module includes a handheld computer. Some PDAs offer programmable capability and connectivity to various types of long range wireless networks. An example of this type of device is the PalmPilot™ or Palm series of devices manufactured by 3-COM™. In these embodiments where a programmable network module is used, such as a PalmPilot, PageWriter or programmable cell phone, the programmable nature of the devices facilitates the implementation of industry-standard designs and allows for the development of a program written for the devices.

In one embodiment, a special manufactured device may be manufactured to serve the needs of the system user.

In one embodiment, the device is directly connected to a network module that is manufactured as an integrated unit.

Long Range Wireless Network

The network module incorporates a communications module to connect to a long range, bidirectional network. Such a system incorporates an existing wireless communications network, such as a cellular network, satellite network, paging network, narrowband PCS, narrowband trunk radio, or other wireless communication network. Combinations of such networks and other embodiments may be substituted without departing from the present system.

In one embodiment, the long range wireless network includes a cellular communications network. In one embodiment, the long range wireless network includes a paging network. In one embodiment the long range wireless network includes a satellite network. In one embodiment the long range wireless network includes a wideband or narrowband PCS network. In one embodiment the long range wireless network includes a wideband or narrowband trunk radio module. Other networks are possible without departing from the present system. In one embodiment, the network module supports multiple network systems, such as a cellular module and a two-way paging module, for example. In such embodiments, the system may prefer one form of network communications over another and may switch depending on a variety of factors such as available service, signal strength, or types of communications being supported. For example, the cellular network may be used as a default and the paging network may take over once cellular service is either weak or otherwise unavailable. Other combinations are possible without departing from the present system.

The long range wireless network may include any consumer or proprietary network designed to serve users in range of the detection system, including, but not limited to, a cellular network such as analog or digital cellular systems employing such protocols and designs as CDPD, CDMA, GSM, PDC, PHS, TDMA, FLEX™, ReFLEX™, iDEN™, TETRA™, DECT, DataTAC™, and Mobitex™, RAMNET™ or Ardis™ or other protocols such as trunk radio, Microburst™, Cellemetry™, satellite, or other analogue or digital wireless networks or the control channels or portions of various networks. The networks may be proprietary or public, special purpose or broadly capable. However, these are long range networks and the meaning imposed herein is not to describe a premises or facility based type of wireless network.

The long range wireless network may employ various messaging protocols. In one embodiment Wireless Application Protocol (WAP) is employed as a messaging protocol over the network. WAP is a protocol created by an international body representing numerous wireless and computing industry companies. WAP is designed to work with most wireless networks such as CDPD, CDMA, GSM, PDC, PHS, TDMA, FLEX, ReFLEX, iDEN, TETRA, DECT, DataTAC, and Mobitex and also to work with some Internet protocols such as HTTP and IP. Other messaging protocols such as iMode™, WML, SMS and other conventional and unconventional protocols may be employed without departing from the design of the present embodiment.

As an example, these long range communication protocols described above may include, but are not limited to, cellular telephone protocols, one-way or two-way pager protocols, and PCS protocols. Typically, PCS systems operate in the 1900 MHZ frequency range. One example, known as Code-Division Multiple Access (CDMA, Qualcomm Inc., one variant is IS-95) uses spread spectrum techniques. CDMA uses the fill available spectrum and individual messages are encoded with a pseudo-random digital sequence. Another example, Global Systems for Mobile communications (GSM), is one of the leading digital cellular systems and allows eight simultaneous calls on the same radio frequency. Another example, Time Division Multiple Access (TDMA, one variant known as IS-136) uses time-division multiplexing (TDM) in which a radio frequency is time divided and slots are allocated to multiple calls. TDMA is used by the GSM digital cellular system. Another example, 3G, promulgated by the ITU (International Telecommunication Union, Geneva, Switzerland) represents a third generation of mobile communications technology with analog and digital PCS representing first and second generations. 3G is operative over wireless air interfaces such as GSM, TDMA, and CDMA. The EDGE (Enhanced Data rates for Global Evolution) air interface has been developed to meet the bandwidth needs of 3G. Another example, Aloha, enables satellite and terrestrial radio transmissions. Another example, Short Message Service (SMS), allows communications of short messages with a cellular telephone, fax machine and an IP address. Messages typically have a length of 160 alpha-numeric characters. Another example, General Packet Radio Service (GPRS) is another standard used for wireless communications and operates at transmission speeds far greater than GSM. GPRS can be used for communicating either small bursts of data, such as e-mail and Web browsing, or large volumes of data.

In one embodiment, a long range communication protocol is based on one way or two way pager technology. Examples of one way pager protocols include Post Office Code Standardisation Advisory Group (POCSAG), Swedish Format (MBS), the Radio Data System (RDS, Swedish Telecommunications Administration) format and the European Radio Message System (ERMES, European Telecommunications Standards Institute) format, Golay Format (Motorola), NEC-D3 Format (NEC America), Mark IV/VI Formats (Multitone Electronics), Hexadecimal Sequential Code (HSC), FLEX™ (Motorola) format, Advanced Paging Operations Code (APOC, Philips Paging) and others. Examples of two way pager protocols include ReFLEX™ (Motorola) format, InFLEXion™ (Motorola) format, NexNetTm (Nexus Telecommunications Ltd. of Israel) format and others.

Other long range communication protocols are also contemplated and the foregoing examples are not to be construed as limitations but merely as examples.

The Short Range Wireless Network

In one embodiment, the short range wireless network utilizes a spread spectrum frequency hopping transceiver. This transceiver may communicate using a protocol compatible with BLUETOOTH®. BLUETOOTH® refers to a wireless, digital communication protocol using a low form factor transceiver that operates using spread spectrum frequency hopping at a frequency of around 2.45 GHz.

BLUETOOTH® is a trademark registered by Telefonaktiebolaget LM Ericsson of Stockholm, Sweden and refers to technology developed by an industry consortium known as the BLUETOOTH® Special Interest Group. BLUETOOTH® operates at a frequency of approximately 2.45 GHz, utilizes a frequency hopping (on a plurality of frequencies) spread spectrum scheme, and as implemented at present, provides a digital data transfer rate of approximately 1 Mb/second. Future implementations will include higher data transfer rates. In one embodiment, the present system includes a transceiver in compliance with BLUETOOTH® technical specification version 1.0, herein incorporated by reference. In one embodiment, the present system includes a transceiver in compliance with standards established, or anticipated to be established, by the Bluetooth Special Interest Group.

In one embodiment, the present system includes a transceiver in compliance with standards established, or anticipated to be established, by the Institute of Electrical and Electronics Engineers, Inc., (IEEE). The IEEE 802.15 WPAN standard is anticipated to include the technology developed by the BLUETOOTH® Special Interest Group. WPAN refers to Wireless Personal Area Networks. The IEEE 802.15 WPAN standard is expected to define a standard for wireless communications within a personal operating space (POS) which encircles a person.

In one embodiment, the transceiver includes a wireless, bidirectional, transceiver suitable for short-range, omni-directional communication that allows ad hoc networking of multiple transceivers for purposes of extending the effective range of communication. Ad hoc networking refers to the ability of one transceiver to automatically detect and establish a digital communication link with another transceiver. The resulting network, known as a piconet, enables each transceiver to exchange digital data with the other transceiver. According to one embodiment, BLUETOOTH® involves a wireless transceiver transmitting a digital signal and periodically monitoring a radio frequency for an incoming digital message encoded in a network protocol. The transceiver communicates digital data in the network protocol upon receiving an incoming digital message.

According to one definition, and subject to the vagaries of radio design and environmental factors, short range may refer to systems designed primarily for use in and around a premises and thus, the range generally is below a mile. Short range communications may also be construed as point-to-point communications, examples of which include those compatible with protocols such as BLUETOOTH®, HomeRF™, and the IEEE 802.11 WAN standard (described subsequently). Long-range, thus, may be construed as networked communications with a range in excess of short range communications. Examples of long range communication may include, Aeris MicroBurst cellular communication system, and various networked pager, cellular telephone or, in some cases, radio frequency communication systems.

In the event that the present subject matter includes a transceiver compatible with BLUETOOTH® protocol, for example, then the device may have sufficient range to conduct bidirectional communications over relatively short range distances, such as approximately 10 to 1,000 meters or more. In some applications, this distance allows communications throughout a premise.

The network module may include a separate, integrated or software based short range bidirectional wireless module. The short range network may be based upon HomeRF, 802.11, BLUETOOTH® or other conventional or unconventional protocols. However, these are short range networks and the meaning imposed herein is to include premises and facility based wireless networks and not to describe long range networks such as cellular telephone networks used to communicate over long distances. Such a system may include programmable or automatically selecting electronics to decide whether to conduct communications between the network module and an optional base station using the short range module or the network module. In one embodiment the system may employ different portions of the network to provide short range or long range network connections, depending on the distance between the devices and the base stations. In one such embodiment, the network automatically adjusts for different required transmission distances.

In one embodiment, the transceiver is compatible with both a long range communication protocol and a short range communication protocol. For example, a person located a long distance away, such as several miles, may communicate with the transceiver using a cellular telephone compatible with the long range protocol of transceiver.

Other short range communication protocols are also contemplated and the foregoing examples are not to be construed as limitations but merely as examples.

Networks Connected to the Premises Base Station

In one embodiment, the present system communicates with a device referred to herein as central communication base station. Central communication base station may include a first transceiver compatible with BLUETOOTH® or other short range wireless network as described herein. Base station may provide a repeater service to receive a message using BLUETOOTH® and to retransmit the message using a different communication protocol or also using BLUETOOTH® communication protocol.

Base station may also include a second transceiver or a wired interface having access to another communication network. The second transceiver or wired interface may retransmit the signal received from the device or received from some other device. In this way, central communication base station may serve to extend the communication range of the device. For example, a message between the device and an emergency-dispatch center may be coupled to communication with the base station connected network and a short range wireless network. Communications between the present subject matter and a device coupled to communicate with the base station connected network may be considered long range communications.

Base station may also communicate bidirectionally within the premise with one or more additional compatible devices. These may be a second device or any other device.

The base station connected network may be a public switched telephone network (PSTN), a pager communication network, a cellular communication network, a radio communication network, the Internet, or some other communication network. It will be further appreciated that with a suitable repeater, gateway, switch, router, bridge or network interface, the effective range of communication of a short range transceiver may be extended to any distance. For example, base station may receive transmissions on a BLUETOOTH® communication protocol and provide an interface to connect with the base station connected network, such as the public switched telephone network (PSTN) using the base station link. In this case, a wired telephone at a remote location can be used to communicate with the device. As another example, the range may be extended by coupling a BLUETOOTH® transceiver with a cellular telephone network, a narrow band personal communication systems (PCS) network, a CELLEMETRY® network, a narrow band trunk radio network or other type of wired or wireless communication network.

Examples of devices compatible with such long range protocols include, but are not limited to, a telephone coupled to the public switched telephone network (PSTN), a cellular telephone, a pager (either one way or two way), a personal communication device (such as a personal digital assistant, PDA), a computer, or other wired or wireless communication device.

In one embodiment, the long distance network may include a telephone network, which may include an intranet or the Internet. Coupling to such a network may be accomplished, for example, using a variety of connections, including a leased line connection, such as a T-1, an ISDN, a DSL line, or other high-speed broadband connection, or it may entail a dial-up connection using a modem. In one embodiment, the long distance network may include a radio frequency or satellite communication network. In addition, one or more of the aforementioned networks may be combined to achieve desired results.

Short range communication protocols, compatible with the base station may include, but are not limited to, wireless protocols such as HomeRF™, BLUETOOTH®, wireless LAN (WLAN), or other personal wireless networking technology. HomeRF™, currently defined by specification 2.1, provides support for broadband wireless digital communications at a frequency of approximately 2.45 GHz.

Other long range and short range communication protocols are also contemplated and the foregoing examples are not to be construed as limitations but merely as examples.

The base station may be compatible with more than one communication protocol. For example, the base station may be compatible with three protocols, such as a cellular telephone communication protocol, a two-way pager communication protocol, and BLUETOOTH® protocol. In such a case, a particular the device may be operable using a cellular telephone, a two-way pager, or a device compatible with BLUETOOTH®.

In one embodiment, the device can communicate with a remote device using more than one communication protocols. For example, the device may include programming to determine which protocol to use for communicating.

The determination of which communication protocol to use to communicate with a remote device may be based on power requirements of each transceiver, based on the range to the remote device, based on a schedule, based on the most recent communication from the remote device, or based on any other measurable parameter. In one embodiment, the device communicates simultaneously using multiple protocols.

In one embodiment, signals generated by the device are received by a central monitoring station. The central monitoring station may include operators that provide emergency dispatch services. An operator at the central monitoring station may also attempt to verify the authenticity of a received alarm signal. In one embodiment, the alarm signal generated by the device is first transmitted to a user, using either a short range or long range communication protocol, who then may forward the alarm signal to a monitoring station if authentic or cancel the alarm signal if the alarm is not valid.

In one embodiment, the device may communicate with a building control or security system by communicating using its transceiver. For example, the device may operate as an auxiliary input to a building control or security system. In which case, if the device detects a security event, by way of a sensor coupled to the device, then an alarm signal is transmitted from the device, via its transceiver, to the building security system. The building security system, if monitored by a central monitoring station, then forwards the alarm signal to the monitoring station. In one embodiment, the device can receive a transmission from a separate building control or security system. If the building security system detects an alarm condition, then the security system can, for example, instruct the device to repeatedly toggle power to load a flashing light visible from the exterior of the building may aid emergency personnel in locating an emergency site. Alternatively, the device can establish communications with a predetermined remote device or a central monitoring service.

In one embodiment, there are various types of networks connected to the base station. These may be telephone networks, modem connections, frame relay systems, spread-spectrum, DSL, cable modems, dedicated line or other similar wire based communication and data networks. In addition, these may be long-range, bi-directional, wireless networks as describe above.

In one embodiment, there is a connection to the Internet using various Internet protocols such as TCP/IP/HTTP/HTCP and others.

In addition, feedback may be transmitted to a remote device based on the operation of the device. For example, if a user issues a command to the device using the cellular telephone, then the display of the phone will indicate the changes arising from the command. In one embodiment, the cellular telephone, the base station, emergency monitoring center, or other device, displays real time information from the device.

Various methods may be used to communicate with, or send a message or instruction to, the device from a remote location. For example, using a cellular telephone, a user may speak a particular phrase, word or phoneme that is recognized by the cellular telephone which then generates and transmits a coded message to the device. As another example, the user may manipulate a keypad on the telephone to encode and transmit a message to the device.

In one embodiment, there are multiple destinations for the transmitted information. This may include a base station (at a home), multiple cell phones (or other network devices—for example, to notify a parent of the use of the device) or an emergency-dispatching center.

Conclusion

Other embodiments are possible and the examples provided herein are intended to be demonstrative and not exclusive or exhaustive of the present invention, which is determined by the scope of the appended claims and the full range of equivalents to which they are entitled.

What is claimed is:

1. A device comprising:
a wireless transceiver adapted to receiver a request for an electronic location signal;
a location determining section coupled to the transceiver and adapted to generate the electronic location signal based on a geographical location; and
a control adapted to prevent transmission of the electronic location signal from the transceiver without activation by a user of the device.

2. The device of claim 1 wherein the control includes a user operable switch.

3. The device of claim 1 further comprising a processor coupled to the transceiver.

4. The device of claim 1 wherein the control includes an executable computer program adapted to verify an authorization code of the request.

5. The device of claim 1 wherein the location determining section includes a global positioning system (GPS) receiver.

6. The device of claim 1 wherein the wireless transceiver is adapted for short range communications.

7. The device of claim 1 wherein the wireless transceiver is adapted for long range communications.

8. The device of claim 1 wherein the wireless transceiver includes a BLUETOOTH® compatible transceiver.

9. The device of claim 1 wherein the wireless transceiver includes a cellular telephone transceiver.

10. The device of claim 1 wherein the wireless transceiver includes a visual display adapted to indicate a geographical heading.

11. The device of claim 1 wherein the wireless transceiver is adapted to communicate with a monitor center.

12. The device of claim 1 further comprising a timer coupled to the control and wherein the control is operated by the timer.

13. A system comprising:
a first wireless transceiver;
a communication network having at least one server and adapted to communicate with the first wireless transceiver;
a location determining program executing on the at least one server and adapted to determine location information corresponding to a geographical location of the first wireless transceiver; and
an authorization program executing on the at least one server and adapted to grant access to the location information to a first group of clients and deny access to the location information to a second group of clients.

14. The system of claim 13 wherein the first wireless transceiver includes a visual display adapted to indicate a geographical heading.

15. The system of claim 13 wherein the first group of clients includes at least one wireless transceiver.

16. The system of claim 13 wherein the at least one server is adapted to communicate with a monitor center.

17. The system of claim 13 wherein the location determining program is adapted to receive information from the first wireless transceiver and wherein the location information is determined as a function of location data received by the location determining program from the first wireless transceiver.

18. The system of claim 13 further comprising a timer coupled to the authorization program.

19. The system of claim 13 further comprising a user operable control coupled to the authorization program.

20. The system of claim 13 further comprising a processor coupled to the first wireless transceiver.

21. The system of claim 13 wherein the authorization program is adapted to receive an authorization code.

22. The system of claim 13 wherein the location determining program receives data from a global positioning system (GPS) receiver.

23. The system of claim 13 wherein the first wireless transceiver is adapted for short range communications.

24. The system of claim 13 wherein the first wireless transceiver is adapted for long range communications.

25. The system of claim 13 wherein the first wireless transceiver includes a BLUETOOTH® compatible transceiver.

26. The system of claim 13 wherein the first wireless transceiver includes a cellular telephone transceiver.

27. A method comprising:
receiving a request for information from a first transceiver;
generating an electrical location signal based on a geographical location of the first transceiver;
conveying the request for information to a service provider;
granting access to the electrical location signal to the service provider; and
terminating access to the electrical location signal to the service provider after a predetermined period of time.

28. The method of claim 27 wherein conveying the request for information includes transmitting the request for information using a wireless transmitter.

29. The method of claim 27 further comprising monitoring a clock signal to determine the predetermined period of time.

30. A method comprising:
receiving a message including an authorization to access electronic location information;
receiving a request to transmit the electronic location signal;
checking authenticity of the authorization;
if the authorization is authentic, then transmitting the electronic location signal; and
if the authorization is not authentic, then preventing transmission of the electronic location signal.

31. The method of claim 30 further comprising receiving a satellite signal and generating the electronic location signal based on the satellite signal.

32. The method of claim 30 wherein transmitting includes conducting a cellular telephone call.

33. The method of claim 30 further comprising translating the message from a first communication protocol to a second communication protocol.

34. A system comprising:
a mobile device having a first short range transceiver and a first long range transceiver;
a second device having a second transceiver in communication with the first transceiver;
location determining means adapted to determine a geographical location of the mobile device; and
a processor controlled authorization checking means to check an authorization received from the second device.

35. The system of claim 34 wherein the mobile device includes the locating determining means.

36. The system of claim 34 further comprising a communication server coupled to a communication network and wherein the location determining means includes a program executing on the communication server.

37. The system of claim 34 further comprising a computer implemented translator in wireless communication with the mobile device and in communication with the second device.

38. A method comprising:
receiving an electronic address for a mobile device;
transmitting a configuration message to the electronic address from a wireless transmitter having a destination address, the configuration message including the destination address; and
awaiting receipt of a location message at the destination address, the location message including a geographical location for the mobile device.

39. The method of claim 38 further comprising transmitting a query to the electronic address requesting transmission of the location message.

40. The method of claim 38 further comprising transmitting an update frequency to the electronic address and receiving the location message after a time interval based on the update frequency.
